(19) United States
(12) Patent Application Publication
(10) Pub. No.: US 2008/0213684 A1
(43) Pub. Date: Sep. 4, 2008

(54) CARRIER FOR ELECTROPHOTOGRAPHIC DEVELOPER, DEVELOPER, IMAGE FORMING METHOD, IMAGE FORMING APPARATUS, AND PROCESS CARTRIDGE

(76) Inventors: Masashi NAGAYAMA, Mishima-shi (JP); Tomio Kondou, Numazu-shi (JP); Shinichiro Yagi, Numazu-shi (JP); Hitoshi Iwatsuki, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/015,109

(22) Filed: Jan. 16, 2008

(30) Foreign Application Priority Data
Jan. 18, 2007 (JP) 2007-008983
Dec. 13, 2007 (JP) 2007-322014

(51) Int. Cl. G03G 9/087; G03G 13/06; G03G 15/08

(52) U.S. Cl. 430/109.3; 430/110.4; 430/97; 399/222

(57) ABSTRACT

To provide a carrier for electrophotographic developer including core particles and a cover layer covering the particles, wherein at least one of the carrier to be supplied in a developing apparatus and carrier contained in the developing apparatus has a weight average particle diameter Dw of 22 μm or more and 32 μm or less, a ratio Dw/Dp of the weight average particle diameter Dw to the number average particle diameter Dp that satisfies the relationship 1.00≦Dw/Dp≦1.20, particles whose particle diameter x (μm) is within a range of 0<x<20 in an amount of 7 wt % or less, and particles whose particle diameter y (μm) is within a range of 0<y<36 in an amount of 90 wt % or more and 100 wt % or less.

### BACKGROUND OF THE INVENTION

1. Field of the Invention

The present invention relates to a carrier for an electrophotographic developer, to a developer, to an image formation method in which a two-component developer is used, to an image forming apparatus, to a developer supply apparatus, and to a process cartridge.

2. Description of the Related Art

In an electrophotographic type of image forming apparatus such as a copier or printer, a latent electrostatic image is formed by exposing the surface of a uniformly charged image bearing member, developing the latent electrostatic image to create a toner image, and then transferring the toner image onto recording paper or another such transfer material. The transfer material carrying the toner image passes through a fixing apparatus to fix the toner onto the transfer material with heat or pressure.

With the above-mentioned image forming apparatus, the developing apparatus that develops the latent electrostatic image on the image bearing member comes in two types: a one-component developing system in which developing is performed by using a toner that contains magnetic particles, and a two-component developing system in which developing is performed by using a developer composed of toner and a carrier.

Of these two, a two-component developing type of developing apparatus has superior developing properties, and is therefore the most common type of image forming apparatus in use today. In particular, many color image forming apparatus that form full-color or multicolor images have come into use in recent years, which has further driven up demand for developing apparatus that involve a two-component developing system.

With the above-mentioned two-component developing type of image forming apparatus, the toner and carrier are stirred inside the developing apparatus, and friction causes the carrier to impart a charge to the toner. The toner electrostatically adheres to the outer surface of the carrier, and the carrier that carries the toner is conveyed to a developing area. When a developing bias has been applied, the toner separates from the carrier, and electrostatically adheres to the latent electrostatic image portion of the image bearing member, forming a toner image. To obtain an image that is durable and has satisfactory stability with a two-component developing system, it is important for a stable amount of charge to be imparted from the carrier to the toner, and to this end it is important for the ability of the carrier to impart a charge to remain stable throughout long-term use.

However, with an ordinary two-component developing type of developing apparatus, the toner is consumed in the course of developing, whereas the carrier is not, and remains in the developing tank. Consequently, carrier that is stirred along with the toner in the developing tank deteriorates as the stirring frequency increases. More specifically, the resin coating can separate from the carrier surface, or toner can adhere to the carrier surface (toner spent), and as a result, the carrier resistance and the developer chargeability gradually decrease, the developing property of the developer rises excessively, and image density can increase or halation can occur.

What is known as a trickle developing type of developing apparatus has been disclosed in Japanese Patent Application Publication (JP-B) No. 02-21591 as a way to solve the above problems. This is a developing apparatus in which carrier is added as toner is consumed by developing, so that the carrier in the developing apparatus is replaced a little at a time, which suppresses change in the amount of charging and stabilizes the image density.

Nevertheless, even with the developing apparatus disclosed in JP-B No. 02-21591, the proportion of degraded carrier in the developing tank steadily increases over extended use, making it difficult to avoid problems such as an increase in image density.

Also, Japanese Patent Application Laid-Open (JP-A) No. 03-145678 discloses that chargeability can be maintained and a decrease in image quality can be suppressed by using a developer that includes, along with a toner, a carrier that has higher resistance than the carrier held ahead of time in the developing apparatus, as a developer that is supplied as needed in the developing apparatus.

Furthermore, JP-A No. 11-223960 discloses that chargeability can be maintained and a decrease in image quality can be suppressed by using a developer that includes, along with a toner, a carrier that imparts a higher charge to the toner, as a supply developer.

However, since the amount of carrier that is replaced in the developing apparatus varies from one point in time to another due to differences in the amount of toner consumption, with the methods disclosed in JP-A Nos. 03-145678 and 11-223960, the resistance or the amount of charge of the developer in the developing apparatus changes, and this tends to cause fluctuation in the image density.

Meanwhile, JP-A No. 08-234550 discloses a method in which are used a plurality of types of supply developer that contains, along with a toner, a carrier that has different properties from those of the carrier held ahead of time in the developing apparatus, and each developer is successively supplied. In actual practice, however, because of the pronounced difference in specific gravity between a toner and a carrier, it is extremely difficult to do as disclosed in JP-A No. 08-234550, which is to successively supply a supply developer that contains a toner along with one of a plurality of carriers with different properties into the developing apparatus without the carriers being mixed together, and because there is more toner than carrier in the developer, degradation of the carrier tends to occur, and a stable image cannot be obtained over an extended period.

Also, when, as discussed in JP-A No. 08-234550, the amount of coating of the silicone coating layer that coats the carrier core is merely increased in order to raise the resistance of carrier to be supplied, although the resistance is raised, the amount of charge of the carrier ends up decreasing, and as a result there is a decrease in reproducibility of the image that is developed, or background soiling occurs.

Consequently, to obtain more stable developing characteristics with a trickle developing system, it is very important to be able to maintain a stable ability in the carrier to impart a charge over an extended period.

Also, with a trickle developing system, it is difficult to control the ratio of toner to carrier in the developer because there is fluctuation not only in the amount of toner, but also in the amount of carrier. In particular, there tends to be a portion of locally higher toner or carrier concentration in the developer at the point when toner or carrier is added to the developing apparatus. In adding toner or carrier to the developing apparatus, if the additional toner and carrier are mixed in advance and supplied as a developer, this local increase in concentration can be mitigated, but in this case the amount of developer supplied depends on the consumption of toner, so there is the possibility that the carrier will not be supplied in the proper amount. As mentioned above, if there is pronounced fluctuation in the ratio of toner to carrier in the developer inside a developing apparatus, then the amount of charge will vary and the image density will tend to fluctuate.

The granular carrier used with a two-component developing system is usually covered with a suitable resin material to prevent filming of the toner onto the carrier surface, to form a uniform carrier surface, to prevent surface oxidation, to prevent a decrease in moisture sensitivity, to extend the service life of the developer, to protect the photoconductor drum from scratches or wear caused by the carrier, to control charge polarity, to adjust the amount of charge, or for other such purposes (see, for example, JP-A No. 58-108548). There are also methods in which various kinds of additive are added to the cover layer (see, for example, JP-B Nos. 01-19584 and 03-628 and JP-A No. 06-202381).

Furthermore, it has been proposed in JP-A No. 05-273789 that an additive be caused to adhere to a carrier surface, and it has been proposed in JP-A No. 09-160304 that the cover layer contain conductive particles that are larger than the cover layer thickness.

Also, in JP-A No. 08-6307 has been proposed the use of a carrier covering material whose main component is a benzoguanamine-n-butyl alcohol-formaldehyde copolymer, and in Japanese Patent (JP-B) No. 2,683,624 it has been proposed that a crosslinked acrylic resin and melamine resin be used as a carrier covering material.

However, problems remain in terms of durability and heat resistance, and other problems include toner-spent on the carrier surface, the attendant instability of the amount of charge, and toner halation. Environmental resistance also needs to be improved.

There has been a dramatic increase in recent years in the need for further stability and higher image quality in electrophotographic images. In particular, there have been attempts at increasing the density and reducing the size of the smallest unit of a latent electrostatic image (a single dot) in an effort to achieve higher image quality, and to this end it is very important that these tiny latent electrostatic images be developed faithfully. Also, reducing variance in the distribution of the amount of developer charge is important in order to obtain stable image quality.

Reducing the diameter of carrier particles is believed to be an effective way to develop a latent electrostatic image faithfully, and the use of various small-diameter carrier particles has been proposed.

JP-A No. 58-144839 proposes a magnetic carrier that has an average particle size of less than 30 μm and is composed of ferrite particles having a spinel structure. However, this is a carrier that is not coated with a resin, and is used at a low developing electric field, so its developing capability is poor, and since it is not resin coated, it has a shorter service life.

Japanese Patent (JP-B) No. 3,029,180 discusses an electrophotographic carrier having carrier particles, wherein this carrier has a 50% average particle diameter (D₅₀) of 15 μm to 45 μm, the carrier contains 1% to 20% carrier particles smaller than 22 μm, contains 3% or less carrier particles smaller than 16 μm, contains 2% to 15% carrier particles of 62 μm or more, and contains 2% or less carrier particles of 88 μm or more, and the carrier is such that its specific surface area S₁ as measured by air transmission method and its specific surface area S₂ as calculated from Formula 1 below satisfy Formula 2.

S₂=(6/ρ·D₅₀)×10⁴ (ρ is the specific gravity of the carrier) Formula 1:

1.2≦S₁/S₂≦2.0 Formula 2:

Using these small-diameter carrier particles has the following advantages.

(1) Because the surface area is larger per unit of volume, a sufficient triboelectric charge can be imparted to each individual toner particle. Therefore, toners with a small amount of charge and toners with charge inversion are rarely produced, and smear in the background area tends not to occur. Also, there is little scattering and blurring of toner particles at the periphery of the dots, so dot reproducibility is good.

(2) Because the surface area is larger per unit of volume and there tends to be no background smear, the average amount of charge in the toner can be lower, and a sufficient image density is obtained.

(3) Because the carrier has a small particle diameter, a dense magnetic brush can be formed. Also, because the head of the brush has excellent fluidity, the head of the brush tends too leave few marks on the image.

Further, JP-A No. 2005-250424 discusses a carrier for an electrophotographic developer, which is composed of magnetic core particles and a resin layer that covers these core particles, in which weight average particle diameter Dw is from 22 μm to 32 μm, and the ratio Dw/Dp of the weight average particle diameter Dw to the number average particle diameter Dp is 1<Dw/Dp<1.20, wherein the carrier contains 0 wt % to 7 wt % particles whose diameter is smaller than 20 μm, contains 90 wt % to 100 wt % particles whose diameter is smaller than 36 μm, and contains 98 wt % to 100 wt % particles whose diameter is smaller than 44 μm. The carrier adhesion that is attributable to a reduction in particle size is suppressed by reducing the amount of micropowder and narrowing the particle size distribution.

Also, when the particle size of a conventional carrier is reduced, irregularities on the core surface shrink, and when viewed macroscopically, the surface looks better and is closer to a smooth state. With a carrier having a smoothed core surface, stress on the carrier particles is dispersed more uniformly in a two-component developer, so the local cover film shaving caused by the concentration of stress can be suppressed, and cover film durability tends to be enhanced.

However, shaving of the carrier cover layer occurs even when stress is uniformly dispersed. When the surface properties of the carrier core are improved, even though stress is uniformly dispersed and cover film shaving is slowed, long-term use still results in shaving over the entire surface of the particles, until almost no cover film remains on the particles. Particles with little remaining cover film are only able to impart a very weak charge to toner, so the carrier particles are no longer able to perform their function. Also, the portion of the core surface that has been exposed by cover film shaving has reduced electrical resistance, so carrier adhesion originating in injection charging is apt to occur, but the resistance is lower over the front ^{[1]} particle surface when no cover film remains on the particles, so it is more likely that a charge will be injected, and as a result carrier adhesion tends to occur.

### BRIEF SUMMARY OF THE INVENTION

The present invention was conceived in light of the above-mentioned problems encountered with related art, and it is an object thereof to provide a carrier for an electrophotographic developer used in a two-component developing type of image forming apparatus, wherein chargeability within the developing apparatus is kept stable, the adhesion of carrier to solid image portions is suppressed over extended use, image density and particle properties (roughness) are good, and changes in the amount of charge caused by toner concentration fluctuation bring about little fluctuation in image density; and to provide a carrier in which impacts through contact between carrier particles are softened, binder resin film shaving over extended use is suppressed, and the effect of scraping off toner-spent component through frictional contact between the carrier particles is maintained; and to provide a developer, an image formation method, an image forming apparatus, and a process cartridge in which this carrier is used.

The inventors conducted diligent research aimed at solving the above problems, and was conceived on the basis thereof.

The above-mentioned problems are solved by present inventions (1) to (16) below.

(1) A carrier for an electrophotographic developer including core particles; and a cover layer covering the particles, wherein the carrier is used in an image forming apparatus that supplies toner and carrier to a developing apparatus in which toner and carrier are contained and that performs developing while discharging excess developer inside the developing apparatus, and wherein at least one of the carrier to be supplied in the developing apparatus and carrier contained in the developing apparatus has a weight average particle diameter Dw of 22 μm or more and 32 μm or less, a ratio Dw/Dp of the weight average particle diameter Dw to the number average particle diameter Dp that satisfies the relationship 1.00≦Dw/Dp≦1.20, particles whose particle diameter x (μm) is within a range of 0<x<20 in an amount of 7 wt % or less, and particles whose particle diameter y (μm) is within a range of 0<y<36 in an amount of 90 wt % or more and 100 wt % or less.

(2) The carrier for an electrophotographic developer according to (1), wherein the cover layer comprises a binder resin and at least one type of hard particles, and a hard particle diameter D1 (μm) and an average thickness h (μm) of a resin portion of the cover layer satisfy the relationship 1<(D1/h)<10.

(3) The carrier for an electrophotographic developer according to (2), wherein the hard particles are any one of alumina particles and particles having alumina base particles.

(4) The carrier for an electrophotographic developer according to any one of (2) and (3), wherein the cover comprises second hard particles in addition to the hard particles, the hard particle diameter D1 (μm) and a second hard particle diameter D2 satisfy the relationship D2<D1, and the second hard particle diameter D2 (μm) and the average thickness h (μm) of the resin portion of the cover layer satisfy the relationship 0.001<(D2/h)<1.

(5) The carrier for an electrophotographic developer according to (4), wherein the second hard particles are any one of titanium oxide particles and surface-treated titanium oxide particles.

(6) The carrier for an electrophotographic developer according to any one of (1) to (5), wherein an average thickness T (μm) from a core particle surface to a surface of the cover layer is within a range of 0.1<T≦3.0.

(7) The carrier for an electrophotographic developer according any one of (1) to (6), wherein the binder resin comprises at least a reaction product of an acrylic resin and an amino resin, or a silicone resin.

(8) The carrier for an electrophotographic developer according to any one of (1) to (7), wherein magnetization as measured when a magnetic field of 1000 oersteds is applied to the carrier is 50 emu/g or more and 100 emu/g or less.

(9) The carrier for an electrophotographic developer according to any one of (1) to (8), wherein the core particles are any one of Mn—Mg—Sr ferrite, Mn ferrite and magnetite.

(10) An electrophotographic developer including: a toner; and the carrier according to any one of (1) to (9).

(11) The electrophotographic developer according to (10), wherein a content of the carrier in the developer to be supplied in the developing apparatus is 3 wt % or more and less than 30 wt %.

(12) The electrophotographic developer according to any one of (10) and (11), wherein a content of the carrier in the developer contained in the developing apparatus is 85 wt % or more and less than 98 wt %.

(13) An image formation method including: forming a latent electrostatic image on an image bearing member; and developing the latent electrostatic image to form a visible image by supplying a toner and carrier to a developing apparatus in which a toner and carrier are contained while discharging excess developer inside the developing apparatus, wherein the carrier according to any one of (1) to (9) is used.

(14) An image forming apparatus including: an image bearing member for bearing thereon a latent electrostatic image; a developing apparatus configured to develop the latent electrostatic image by use of a developer containing a toner and carrier to form a visual image; a developer supply unit configured to supply the toner and carrier to the developing apparatus; and a developer discharge unit configured to discharge residual particles of the developer contained in the developing apparatus, wherein the carrier is the carrier according to any one of (1) to (9).

(15) The image forming apparatus according to (14), including: a container for containing therein a supply developer, the container having a readily deformable shape; and a suction pump for drawing the developer in the container for supply into the developing apparatus.

(16) A process cartridge including: an image bearing member; and a developing apparatus which at least converts a latent electrostatic image formed on the image bearing member into a visible image using a developer including a toner and carrier, the process cartridge being detachably provided to a main body of an image forming apparatus, a main body side of the image forming apparatus being provided with a unit configured to supply toner and carrier to the developing apparatus and with a developer discharge unit configured to discharge excess developer from inside the developing apparatus, wherein the carrier according to any one of (1) to (9) is used.

The present invention will now be described in further detail.

The inventors conducted diligent research aimed at solving the above problems. As a result, they discovered that if developing is performed while toner and carrier are supplied to a developing apparatus that holds toner and carrier, and while excess developer is discharged from inside the developing apparatus, this suppresses change in the amount of charge attributable to degradation of the carrier, the specific surface area of the carrier is increased by reducing the particle size of the carrier, and it is possible to reduce the fluctuation in the amount of charge attributable to toner concentration fluctuation, which tends to occur in the supply of toner and carrier to a developing apparatus by the above-mentioned developing method. However, if the particle size of the carrier is reduced in order to obtain the above advantages, the magnetic constriction applied per particle becomes weaker, so carrier adhesion resistance suffers. The inventors reached that conclusion that the most effective way to obtain the above advantages while still overcoming the above-mentioned drawbacks to the tradeoff relationship is to reduce the micropowder component of the carrier and narrow the particle size distribution, and they discovered that the above problems could be solved by applying a carrier with an ideal particle size distribution to the above-mentioned developing method.

They also discovered that if protrusions produced by hard particles are provided to the surface of the carrier used in the above-mentioned developing method, they will soften the impacts produced by contact among the carrier particles against the binder resin of the carrier cover layer, binder resin film shaving can be suppressed even over extended use, the protrusions produced by the hard particles will exhibit an effect of scraping off (cleaning) the toner-spent component from the carrier surface, and toner-spent can be prevented.

When the amount of electric charge fluctuates, image density also fluctuates. Therefore, the amount of charge is preferably extremely consistent.

The amount of charge is correlated to the ratio of toner to carrier in the developer, and in general, the higher is the toner concentration, the smaller is the amount of charge. This is because the toner coverage varies on the carrier particle surface, and when the coverage is higher, the amount of toner per unit of surface area of the carrier particles increases, and the charging action is dispersed, so the amount of toner charging is smaller.

Therefore, to stabilize the amount of charge, it is preferable for there to be little coverage fluctuation (low sensitivity) with respect to the toner concentration.

The inventors conducted diligent research into a method for suppressing fluctuation in the amount of charge with respect to the toner concentration fluctuation that occurs in a developing method in which toner and carrier are supplied to a developing apparatus and excess developer is discharged from inside the developing apparatus, and as a result they reached the conclusion that it is effective to reduce fluctuation of toner coverage with respect to the carrier surface area, as discussed above.

The coverage of toner with respect to carrier surface area can be calculated from the following equation.

Coverage(%)=(Wₜ/W_{c})×(ρ_{c}/ρₜ)×(D_{c}/Dₜ)×(¼)×100

where D_{c} is the weight average particle diameter (μm) of the carrier, Dₜ is the weight average particle diameter (μm) of the toner, Wₜ is the weight (g) of the toner, W_{c} is the weight (g) of the carrier, ρₜ is the toner true density (g/cm³), and ρ_{c} is the carrier true density (g/cm³). It can be seen from this equation that coverage is a function of the carrier particle diameter D_{c}, and that the smaller is the carrier particle diameter D_{c}, the less fluctuation there is in coverage when the toner concentration (Wₜ/W_{c}) changes. Therefore, the smaller is the carrier particle diameter D_{c}, the less fluctuation there is in the amount of charge when the toner concentration changes, and the amount of charge can be stabilized.

With the carrier of the present invention, the weight average particle diameter Dw thereof is from 22 μm to 32 μm, and preferably within a range of 23 μm to 30 μm. If the weight average particle diameter Dw is less than 22 μm, the magnetic constriction applied to the particles will be weak, so even though the particle size distribution may be sharp, it will still be difficult to prevent carrier adhesion. If the weight average particle diameter Dw is greater than 32 μm, carrier adhesion will be less apt to occur, but the toner will not be faithfully developed with respect to the latent electrostatic image, there will be more variance in dot diameter, and particle properties will suffer.

The term “carrier adhesion” above refers to a phenomenon in which carrier adheres to the image portion or the background portion of a latent electrostatic image. Carrier adhesion is undesirable because it causes problems such as scratching of the photoconductor drum or the fixing roller. Also, if the ratio Dw/Dp of the weight average particle diameter Dw to the number average particle diameter Dp is greater than 1.20, the proportion of microparticles will be larger and carrier adhesion resistance will suffer.

The content of particles in the carrier whose diameter is smaller than 20 μm is preferably 7 wt % or less, and more preferably 5 wt % or less, and even more preferably 3 wt % or less.

If there are more than 7 wt % particles smaller than 20 μm, the particle size distribution will widen, and there will be particles of low magnetization all over the magnetic brush, resulting in a sharp increase in carrier adhesion.

The proportion of carrier particles whose diameter is smaller than 20 μm is preferably 0.5 wt % or more. If it is 0.5 wt % or more, the desired values can be obtained without driving up the cost.

Furthermore, with carrier particles whose weight average particle diameter Dw is from 22 μm to 32 μm, a carrier with a sharp particle size distribution in which there are 90 wt % or more, and preferably 92 wt % or more, particles smaller than 36 μm will have less variance in magnetic constriction of the carrier particles, and carrier adhesion resistance will be greatly improved.

The weight average particle diameter Dw referred to in the present invention in relation to the carrier, the carrier core, and the toner is calculated on the basis of the particle size distribution (relationship between particle size and count frequency) as measured by count standard.

The weight average particle diameter Dw in this case is expressed by the following equation.

D_{w}={1/Σ(nD³)}×{Σ(nD⁴)} (1)

where D is the representative diameter (μm) of the particles in each channel, and n is the total number of particles in each channel. The term “channel” here refers to a length for dividing the particle size range in a particle size graph into equal parts, and a length of 2 μm was employed in the case of the present invention.

The minimum size of the particles stored in each channel was employed as the representative diameter of the particles present in each channel.

The number average particle diameter Dp of the carrier and the carrier core particles in the present invention is calculated on the basis of the particle size distribution as measured by count standard. The number average particle diameter Dp in this case is expressed by the following equation.

Dp=(1/ΣN)×(ΣnD) (2)

where N is the total number of particles measured, n is the total number of particles in each channel, and D is the minimum size of the particles present in each channel (2 μm).

A Micro-Track particle size analyzer (Model HRA9320-X100, made by Honeywell) was used as the particle size analyzer for measuring particle size distribution in the present invention.

The measurement conditions were as follows.
(1) Particle size range: 100 μm to 8 μm
(2) Channel length (channel width): 2 μm
(3) Number of channels: 46
(4) Refractive Index: 2.42

There is provided a carrier for an electrophotographic developer, which is used in a two-component developing type of image forming apparatus, and with which chargeability within the developing apparatus is kept stable, the adhesion of carrier to solid image portions is suppressed over extended use, image density and particle properties (roughness) are good, and changes in the amount of charge caused by toner concentration fluctuation bring about little fluctuation in image density.

### BRIEF DESCRIPTION OF THE SEVERAL VIEWS OF THE DRAWINGS

FIG. 1 is a diagram illustrating the cover layer of the electrophotographic carrier of the present invention;

FIG. 2 is an oblique view of a resistance measurement cell used to measure the resistivity of the carrier;

FIG. 3 is a schematic diagram illustrating the configuration of the image forming apparatus pertaining to the present invention;

FIG. 4 is a diagram illustrating the simplified structure around the developing part of the developing apparatus pertaining to an embodiment of the present invention;

FIG. 5 is a simplified structural diagram of the developer supply part used in the present invention;

FIG. 6A is a diagram illustrating the simplified structure of a nozzle provided to the developer supply apparatus;

FIG. 6B is a cross section in the axial direction thereof,

FIG. 6C is a cross section along the A-A line in FIG. 6B;

FIG. 7 is a cross section of the simplified structure of a screw pump;

FIG. 8 is an oblique view of the state when the developer bearing member has been filled with developer; and

FIG. 9 is a front view of the state when the developer has been discharged from the inside of the developer bearing member, reducing the volume.

### DETAILED DESCRIPTION OF THE INVENTION

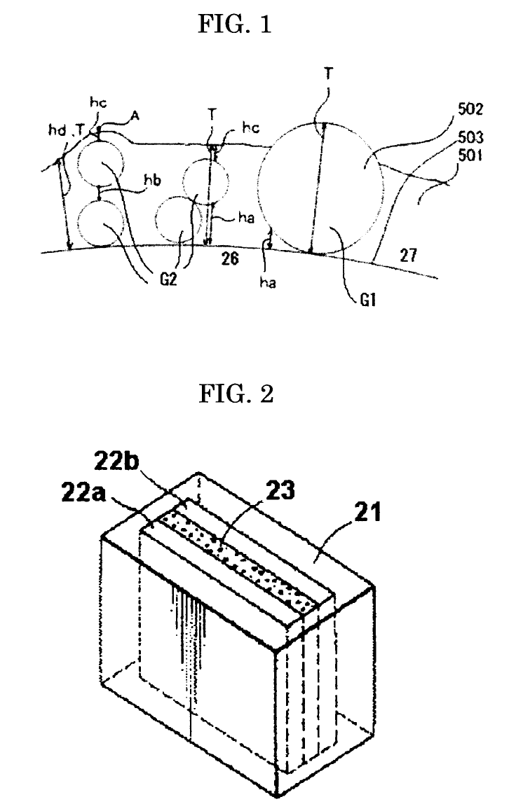

FIG. 1 is a diagram illustrating the cover layer of the electrophotographic carrier used in an embodiment of the present invention. As shown in FIG. 1, the carrier used in the present invention has a core 26 and a cover layer 27 that covers the core 26. This cover layer 27 includes a binder resin and hard particles (hereinafter referred to as first particles G1). The diameter D1 (μm) of the first particles G1 preferably satisfies the relationship 1<(D1/h)<10 with respect to the average thickness h (μm) of the resin portion of the cover layer 27.

The layer that covers the core 26 can also have another layer besides the cover layer 27. Furthermore, for the cover layer 27 other components can also be included as needed in addition to the binder resin, the first particles G1, and second particles G2.

The average thickness h of the resin portion of the cover layer 27 refers to the thickness of a film present in the perpendicular direction with respect to the surface of the core 26, and refers to the average thickness of the resin portion, less the particle portion, out of the thickness from the surface of the core 26 to the surface of the cover layer 27.

The thickness of the resin portion of the cover layer 27 includes the thickness ha of the resin present between the particles and the surface of the core 26, the thickness hb of the resin present in between particles, the thickness hc of the resin present over particles, and the thickness hd of the resin present over the core 26.

The average thickness h of the resin portion of the cover layer 27 can be measured, for example by using a transmission electron microscope (TEM) to observe a cross section of the carrier. More specifically, the thickness of the resin portion of the cover layer 27 (the thickness ha of the resin present between the particles and the core surface, the thickness hb of the resin present in between particles, the thickness hc of the resin present over particles, and the thickness hd of the resin present over the core) is measured at intervals of 0.2 μm using a transmission electron microscope (TEM), 50 measurement values are obtained, and the average of these measured values is termed the average thickness h of the resin portion of the cover layer 27.

As to the specific calculation method, the value of the average thickness h of the resin portion of the cover layer 27 is obtained by totaling the measurement values obtained by the above method, and dividing the sum thus obtained by the number of measured values. This number of measured values is counted by using one each of the thickness ha of the resin present between the particles and the surface of the core 26, the thickness hb of the resin present in between particles, the thickness hc of the resin present over particles, and the thickness hd of the resin present over the core 26.

For example, at measurement point A shown in FIG. 1, since the above-mentioned hb and hc are present, there are two measurement values at measurement point A.

Also, with the measurement method described above, of the 50 measured values, when a plurality of measured values (such as the above-mentioned ha and hc) are obtained as measured values for the thickness of the resin portion of the cover layer 27 at the last measured site, the total of the above-mentioned measured values is divided by the number of measured values, which is “49+the measured value at the last measurement point,” and this quotient is termed the average thickness h of the resin portion of the cover layer 27.

The diameter D1 (μm) of the hard particles (hereinafter referred to as the first particles G1) included in the cover layer 27 shall satisfy the relationship 1<(D1/h)<10 with respect to the average thickness h (μm) of the resin portion of the cover layer 27, and preferably shall satisfy the relationship 1<(D1/h)<5.

If the diameter D1 of the first particles G1 and the average thickness h of the resin portion of the cover layer 27 satisfy the above relational formula, then the first particles G1 will stick out farther than the cover layer 27 of the carrier. The effect of this protruding portion is that when the developer is stirred for triboelectric charging, the powerful impact imparted to the binder resin of the cover layer 27 by the frictional contact between the toner and the carrier, or between the carrier particles, will be softened. This suppresses binder resin film shaving in the carrier cover layer 27, which is the place where charging occurs.

Also, a cleaning effect can be obtained if the toner-spent component adhering to the carrier surface is scraped off by particles present as protrusions on the surface of the cover layer 27, as a result of frictional contact between the carrier particles. This effectively prevents the occurrence of the toner-spent phenomenon.

If D/h is 1 or less, the first particles may be embedded in the binder resin, so that the effect of adding the first particles G1 to the cover layer 27 cannot be fully realized. If D/h is 10 or more, there may be too little contact surface area between the first particles G1 and the binder resin, so that the first particles G1 do not have sufficient binding force with respect to the carrier particles, and the first particles G1 end up readily falling off the carrier particle surface.

The cover layer 27 preferably contains second hard microparticles (hereinafter referred to as the second particles G2) so that the cover layer will, on average, have enough strength. The diameter D2 (μm) of the second particles G2 preferably is in a relationship of D2<D1 with the diameter D1 of the first particles G1, and satisfies 0.001<(D2/h)<1, and more preferably 0.01<(D2/h)<0.5, with respect to the average thickness h (μm) of the resin portion of the cover layer 27.

The second particles G2 can be dispersed and enclosed in the cover layer 27 by making the diameter D2 of the second particles G2 smaller than the average thickness of the cover layer 27. This means that the average strength of the cover layer can be increased.

The volume specific resistance of the second particles G2 is preferably 1.0×10¹²Ω·cm or less, and more preferably 1.0×10¹⁰Ω·cm or less, and even more preferably 1.0×10⁸Ω·cm or less. Setting the volume specific resistance of the second particles G2 low (to 1.0×10¹² Ω·cm or less) keeps the charge imparting ability of the cover layer 27 suitably low, and allows the density of the image that is ultimately obtained to be raised.

The first particles G1 may be microparticles with high electrical conductivity. Conductivity may be adjusted by blending particles that have been treated to raise conductivity with particles that have not. The conductivity of conductive microparticles themselves may be adjusted by adjusting the extent of the treatment for raising conductivity.

There are no particular restrictions on the method for imparting electrical conductivity to the microparticles, but an example is to form a conductive cover layer on the surface of base particles. In particular, a conductivity imparting effect that is comparable to that of carbon black can be achieved by using a structure in which a tin dioxide layer and a conductive cover layer composed of tin dioxide and indium oxide and provided over the tin dioxide layer are provided to the surface of base particles.

However, even if a conductive cover layer composed of tin dioxide and indium oxide is formed directly on the base surface, the electrical effect of the base particles may be so great that good conductivity cannot be obtained. Also, even if the base is directly covered with a mixed liquid of a tin oxide hydrate and an indium oxide hydrate, it may be difficult for the base surface to be uniformly covered, resulting in problems with quality.

A more uniform conductive cover layer can be formed by first coating the base particle surface with a material that is commonly used as a coating material, such as aluminum oxide, zinc oxide, or zirconium oxide, and then covering the base particles with a mixed liquid of a tin oxide hydrate and an indium oxide hydrate. However, even when these coating materials are used as under-layers, good conductivity often cannot be obtained because of the electrical effect of the coating materials. In view of this, tin dioxide was used for a coating material that forms an under-layer, whereupon the conductive cover layer that was the over-layer could be fixed uniformly and securely, and good conductivity could be obtained without any adverse electrical effect from the under-layer. As long as the effect of the particles is not compromised, a small amount of indium oxide component can also be mixed into the under-layer without any problem.

The improvement effect will be even more pronounced if the base of the conductive microparticles is one or more of aluminum oxide, titanium dioxide, zinc oxide, silicon dioxide, barium sulfate, and zirconium oxide. The reason for this seems to be that there is better affinity with the conductivity treatment of the particle surface, and the conductivity treatment effect is manifested better. In particular, aluminum oxide and titanium dioxide easily satisfy the color tone conditions, and an especially favorable tone is easily obtained with aluminum oxide. The present invention is not limited to the above-mentioned particles, however, and any other particles that exhibit a good effect can also be used. In the case of titanium dioxide, it may have a rutile, anatase, or other structure.

The following is an aspect of the more detailed method for manufacturing conductive microparticles that are suited to the present invention. This is just an example of a production method, however, and the method for producing conductive microparticles of the present invention is not limited to this method.

There are various methods for forming a tin dioxide hydrate under-layer coating film, but examples include a method in which a solution of a tin salt or a stannate is added to an aqueous suspension of a white inorganic pigment, and then add an alkali or an acid, and a method in which a tin salt or a stannate are added separately and in parallel with an alkali or an acid, and a coating treatment is performed. The latter, parallel addition, method is suited to uniformly covering the surface of white inorganic pigment particles with a tin oxide hydrate, and it is preferable here if the aqueous suspension is heated to and held at 50° C. to 100° C. The pH in the parallel addition of the tin salt or stannate and the alkali or acid is from 2 to 9. Since the isoelectric point of a tin oxide hydrate is a pH of 5.5, it is important to maintain the pH at 2 to 5, or at pH 6 to 9, which allows the tin hydration reaction product to be uniformly deposited on the surface of the white inorganic pigment particles.

Examples of tin salts that can be used include tin chloride, tin sulfate, and tin nitrate. Examples of stannates that can be used include sodium stannate and potassium stannate.

Examples of alkalies that can be used include sodium hydroxide, potassium hydroxide, sodium carbonate, potassium carbonate, ammonium carbonate, aqueous ammonia, and ammonia gas, while examples of acids include hydrochloric acid, sulfuric acid, nitric acid, and acetic acid.

The covering amount of the tin dioxide hydrate is 0.5 wt % to 50 wt %, and preferably 1.5 wt % to 40 wt %, as SnO₂, with respect to the base particles. If the amount is less than 0.5 wt %, the covering state of indium oxide hydrate including the tin oxide that covers from above will not be uniform, and furthermore the effect of the base particles will raise the volume specific resistance of the powder. If 50 wt % is exceeded, more of the tin oxide hydrate will not be securely bonded to the surface of the base particles, and the coverage will tend to be uneven.

Next, there are various methods for forming a covering of indium oxide hydrate including tin dioxide of the over-layer, but it is preferable to use a method in which an alkali and a mixed solution of a tin salt and an indium salt are added separately and in parallel, because this way the film of tin oxide hydrate already formed will not be dissolved. It is more preferable here to heat the aqueous suspension to between 50° C. and 100° C. It is important to maintain the pH at 2 to 9, and preferably pH at 2 to 5 or pH at 6 to 9, in the parallel addition of the mixed solution and the alkali, as this allows the tin and indium hydration reaction products to be uniformly deposited.

Examples of tin raw materials that can be used include tin chloride, tin sulfate, and tin nitrate. Examples of indium raw materials that can be used include indium chloride and indium sulfate.

The amount of tin dioxide added, as SnO₂, is 0.1 wt % to 20 wt %, and preferably 2.5 wt % to 15 wt %, with respect to the In₂O₃. The desired conductivity will not be obtained if the amount is either too large or too small.

The amount of indium oxide treatment, as In₂O₃, is 5 wt % to 200 wt %, and preferably 8 wt % to 150 wt %, with respect to the inorganic pigment of the base. The desired conductivity will not be obtained if the amount is too small, but if the amount is too large, there will be almost no increase in conductivity, and this is also unfavorable because the cost will be higher.

As used herein, a “conductive” powder means that the powder has a volume specific resistance of 1Ω·cm to 500Ω·cm. As shown in the Examples given below, it is possible with the present invention to obtain a white conductive powder with extremely good conductivity of 100Ω·cm or less, which is comparable to that of an antimony-containing powder, and in some cases 10Ω·cm or less.

Heat treatment is preferably carried out in a non-oxidative atmosphere at 350° C. to 750° C. The volume specific resistance of the powder can be reduced by 2 to 3 decimal places as compared to when the heat treatment is performed in air.

An inert gas can be used to create the non-oxidative atmosphere. Examples of inert gases that can be used include nitrogen, helium, argon, and carbon dioxide. For industrial purposes, performing the heat treatment while nitrogen gas is blown in is preferable in terms of cost, and the product will have more stable properties.

The temperature during heating is 350° C. to 750° C., and preferably 400° C. to 700° C. The desired conductivity will tend not to be obtained if the temperature is either above or below this range. Also, if the heating duration is too short, there will be no heating effect, but if it is too long, no further effect can be anticipated, so about 15 minutes to 4 hours is suitable, and about 1 hour to 2 hours is preferable.

Furthermore, if the powder resistivity of the conductive microparticles exceeds 200Ω·cm, the ability to lower the resistance of the conductive microparticles will be low, and a large quantity of conductive microparticles will be required to adjust the resistance of the carrier to a suitable value. Since the proportion accounted for by these particles will be much larger than the proportion accounted for by the binder resin on the carrier surface, the proportion accounted for by the binder resin will be inadequate where the electrical charge is generated, and satisfactory charging will not be possible. In addition, since the amount of particles is much larger than the amount of binder resin, the particles cannot be held properly by the binder resin, and tend to fall out, so the amount of fluctuation in charge, resistance, etc., increases, and sufficient durability cannot be obtained.

The volume specific resistance of the conductive microparticles, the first particles G1, and the second particles G2 in the present invention can be measured as follows, for example.

A sample is put in a polyvinyl chloride cylinder with an inside diameter of 1 inch, and the top and bottom of the cylinder are sandwiched by electrodes. These electrodes are put in a press and subjected to a pressure of 15 kg/cm² for 1 minute. With the pressure still applied, the resistance (r) is then measured with an LCR meter. The resistance value thus obtained is plugged into the following Mathematical Formula 1 to find the volume specific resistance.

Volume specific resistance(Ω·cm)=(2.54/2)²×(π/H×r) (1)

where H is a value expressing the thickness of the sample, and r is a value expressing the resistance of the sample.

If the value of D2/h is 1 or more, the second particles G2 will be too large with respect to the thickness of the cover layer 27, and the effect of dispersing these particles and increasing the average strength of the cover layer will tend not to be obtained. If D2/h is 0.001 or less, the second particles G2 will be too small in diameter with respect to the thickness of the cover layer 27, so again the effect will tend not to be obtained.

The average thickness T (μm) from the surface of the core 26 to the surface of the cover layer 27 is preferably 0.1<T<3.0, and more preferably 0.1<T<2.0.

If the average thickness T from the surface of the core 26 to the surface of the cover layer 27 is less than 0.1 μm, the total thickness of the cover layer 27, as a film that covers the carrier core 26, will be too thin, so the cover layer 27 will tend to be shaved down, leaving the carrier core 26 exposed, and this lowers the durability of the carrier.

If the average thickness T from the surface of the core 26 to the surface of the cover layer 27 is greater than 3.0 μm, however, the film formed on the surface of the core 26 will be too thick, so magnetization of the carrier will tend to decrease, and carrier adhesion may occur. The average thickness h (μm) of the resin portion of the cover layer 27 is preferably 0.04 μm to 2 μm, and more preferably 0.04 μm to 1 μm.

The volumetric average particle diameter D1 of the first particles G1 is preferably 0.05 μm to 3 μm, and more preferably 0.05 μm to 1 μm. The diameter D2 of the second particles G2 is preferably 0.005 μm to 1 μm, and more preferably 0.01 μm to 0.2 μm.

As shown in FIG. 1, the thickness T from the surface of the core 26 to the surface of the cover layer 27 refers to a different thickness from the average thickness h of the resin portion of the cover layer 27 discussed above, and instead refers to the thickness from the surface of the core 26 to the surface of the cover layer 27 at each point over the carrier surface.

As shown in FIG. 1, if the diameter of the particles added to the cover layer 27 is larger than the thickness of the resin portion of the cover layer 27, then the diameter of these particles will correspond to the thickness T from the surface of the core 26 to the surface of the cover layer 27.

The thickness T from the surface of the core 26 to the surface of the cover layer 27 is obtained, for example, by using a transmission electron microscope (TEM) to observe a cross section of the carrier, measuring the thickness from the surface of the core 26 to the surface of the cover layer 27 at 50 points 0.2 μm apart over the carrier surface, and averaging these measured values.

Examples of the first particles G1 include alumina particles, silica particles, titania particles, and zinc oxide particles. Of these, alumina particles are particularly favorable because they have good affinity with the binder resin used for the covering material of the carrier, and they also have excellent adhesion and dispersibility, and furthermore, since they are extremely hard, they are resistant to cracking and wear with respect to stress within a developing apparatus 10, and protect the cover layer over an extended period, which allows a toner-spent scraping effect to be achieved.

The alumina particles preferably have a diameter of 5 μm or less, and any type can be used, such as particles that have not been surface treated, or particles that have undergone a surface treatment such as a hydrophobic treatment. The silica can be a type used for toner, or another type, and any type can be used, such as particles that have not been surface treated, or particles that have undergone a surface treatment such as a hydrophobic treatment. The above-mentioned conductive microparticles may also be used as the first particles G1.

The amount in which the first particles G1 are contained in the cover layer 27 is preferably 10 wt % to 80 wt %, and more preferably 20 wt % to 60 wt %.

If the first particles G1 are contained in the cover layer 27 in an amount less than 10 wt %, then the first particles G1 will account for too small a proportion compared to the proportion accounted for by the binder resin on the carrier particle surface, so the first particles G1 will have less effect of softening the contact and the attendant powerful impact to the binder resin, and adequate durability may not be obtained.

On the other hand, if the amount is over 80 wt %, the first particles G1 will account for too large a proportion compared to the proportion accounted for by the binder resin on the carrier surface, which means that the binder resin, which is where charging occurs, will not account for a large enough proportion, and sufficient charging capability may not be achieved. Furthermore, since the amount of first particles G1 will be too large compared to the amount of binder resin, the binder resin will not be able to sufficiently hold the first particles G1, the first particles G1 will be prone to falling out, the amount of fluctuation in charge, resistance, etc., increases, and sufficient durability may not be obtained.

Here, the amount in which the first particles G1 are contained in the cover layer 27 is expressed by the following Formula (2).

First particle G1 content (wt %)=[{content of first particles G1}÷{total amount of material included in the cover layer 27 (first particles G1+second particles G2+binder resin+other components)}]×100 (2)

One or more types of particle selected from among titanium oxide, zinc oxide, tin oxide, surface treated titanium oxide, surface treated zinc oxide, and surface treated tin oxide can be used favorably as the second particles G2.

These particles have suitable hardness, have good affinity with the resin used for the coating material of the carrier, and have excellent adhesion and dispersibility, and titanium oxide or surface treated titanium oxide is particularly favorable as the second particles G2.

Even when material other than the above is used as the particle base, a good effect can still be obtained for the same reasons as discussed above, as long as dispersibility is increased by subjecting the particle surface of a surface treatment such as a hydrophobic treatment, or the particle size and volume specific resistance are brought within the above-mentioned ranges by performing a surface treatment such as a conductivity treatment.

The amount in which the second particles G2 are contained in the cover layer 27 is preferably 2 wt % to 50 wt %, and more preferably 2 wt % or 30 wt %.

The larger is the amount in which the second particles G2 are contained in the cover layer 27, the better will be their effect of raising strength, but if the content of second particles G2 is over 50 wt %, the state of dispersal of the second particles G2 in the cover layer 27 will be markedly inferior. If the dispersal state of the particles worsens, some of the second particles G2 will agglomerate within the cover layer 27, so on average the effect of the second particles G2 will tend not to be manifested.

On the other hand, if the amount in which the second particles G2 are contained in the cover layer 27 is less than 2 wt %, they will be contained in too small an amount, and the effect of adding the second particles G2 will not be adequately obtained. The amount in which the second particles G2 are contained in the cover layer 27 is expressed by the following Formula (3).

Second particle G2 content (wt %)=[{content of second particles G2}÷{total amount of material included in the cover layer 27 (first particles G1+second particles G2+binder resin+other components)}]×100 (3)

A reaction product of an acrylic resin and an amino resin, and a silicone resin are both favorable examples of the binder resin used for the cover layer 27 of the carrier particles. There are no particular restrictions on a reaction product of an acrylic resin and an amino resin and any reaction product can be suitably selected according to the intended purpose, but it is preferable to use cross-linking product of an acrylic resin and an amino resin.

There are no particular restrictions on acrylic resin, and any acrylic resin can be suitably selected according to the intended purpose, but of these, it is preferable to use one with a glass transition temperature (Tg) of 20° C. to 100° C., and more preferably 25° C. to 80° C. If the glass transition temperature (Tg) of the acrylic resin is within this range, the acrylic resin will have the proper elasticity to absorb impact during contact and the attendant powerful impacts to the binder resin brought about by friction between the carrier particles or by friction between the toner and the carrier during the stirring that is performed to triboelectrically charge the developer. This allows the cover layer to be kept undamaged.

If the glass transition temperature (Tg) is below 20° C., the binder resin will undergo blocking even at normal temperature, and storage stability may be so poor as to preclude practical use. On the other hand, if the glass transition temperature (Tg) is over 100° C., the binder resin will be too hard and brittle to absorb impact, this brittleness will cause binder resin shaving, and these particles cannot be supported and may tend to fall out.

There are no particular restrictions on the amino resin, and any amino resin known in the past can be suitably selected as dictated by the objective. For example, the ability to impart a charge can be markedly increased by using guanamine or melamine.

There are no particular restrictions on the silicone resin, and any commonly known silicone resin can be suitably selected as dictated by the objective. Examples include a straight silicone resin composed solely of organosiloxane bonds, and silicone resins that have been modified with an alkyd resin, polyester resin, epoxy resin, acrylic resin, urethane resin, or the like.

The above-mentioned silicone resins can be commercially available products, and examples of straight silicone resins include KR271, KR255, and KR152 made by Shin-Etsu Chemical Industry, and SR2400, SR2406, and SR2410 made by Dow Corning Toray Silicone.

Examples of modified silicone resins include KR206 (alkyd modified), KR5208 (acrylic modified), ES-1001N (epoxy modified), and KR305 (urethane modified) made by Shin-Etsu Chemical Industry, and SR2115 (epoxy modified) and SR2110 (alkyd modified) made by Dow Corning Toray Silicone.

A silicone resin can be used by itself, but it is also possible to use a component that undergoes a crosslinking reaction, a component that is adjusts the charge amount, or the like at the same time.

The binder resin used for the cover layer 27 of the carrier particles can be any one that is commonly used as a carrier covering resin, as needed, in addition to the resins listed above. Examples include polyvinyl resin, polystyrene resin, halogenated olefin resin, polyester resin, polycarbonate resin, polyethylene resin, polyvinyl fluoride resin, polyvinylidene fluoride resin, polytrifluoroethylene resin, polyhexafluoropropylene resin, a copolymer of vinylidene fluoride and vinyl fluoride, and fluoroterpolymers such as a terpolymer of tetrafluoroethylene, vinylidene fluoride, and a non-fluorinated monomer. These can be used singly, or two or more may be used together.

The cover layer 27 can be formed, for example, by dissolving the first particles G1, the second particles G2, the binder resin, and so forth in a solvent to prepare a coating solution, then uniformly coating the surface of the core 26 with this coating solution by a known coating method, and drying and then baking the coating. Examples of the coating method here include dipping, rolling fluidized bed method, and spraying.

There are no particular restrictions on the above-mentioned solvent, which can be suitably selected as dictated by the intended purpose, but examples include toluene, xylene, methyl ethyl ketone, methyl isobutyl ketone, cellosolve butyl acetate, and butyl cellosolve.

There are no particular restrictions on the above-mentioned baking, which may be accomplished by an external heating process, or an internal heating process, but examples include baking in a fixed electric furnace, fluidized electric furnace, rotary electric furnace, burner furnace, or the like, and using microwaves.

There are no particular restrictions on the core 26, which can be suitably selected as dictated by the intended purpose from among materials known as electrophotographic two-component carriers, but favorable examples include ferrite, magnetite, iron, and nickel. When the effect on the environment, which has become much more of a concern in recent years, is taken into account, if a ferrite is used, it is preferably not a conventional copper-zinc ferrite, and is instead a manganese ferrite, Mn—Mg ferrite, Mn—Mg—Sr ferrite, or the like. Mn—Mg—Sr ferrite, manganese ferrite, and magnetite will be discussed in detail below, but they are materials that have high magnetization, and are therefore effective at suppressing carrier adhesion.

A major problem with conventional small-diameter carriers is that they are prone to carrier adhesion, and this is a source of scratching of the photoconductor drum or the fixing roller, so practical application has been problematic.

In particular, if the carrier has an average particle size of less than 32 μm, roughness is greatly improved and image quality is higher, but carrier adhesion becomes much more likely to occur, which poses a serious problem. The inventors conducted diligent research into this problem, which revealed the following.

Carrier adhesion to the image portion or to the image background portion occurs when Fm<Fc and carrier particles or cut pieces of the magnetic brush adhere (Fm: magnetic constriction force, Fc: force that brings about carrier adhesion).

The force Fc that brings about carrier adhesion is related to the developing potential, background potential, centrifugal force exerted on the carrier, resistance of the carrier, and amount of developer charge. Therefore, to prevent carrier adhesion, it is effective to set the various parameters so that Fc will be smaller, but at present it is difficult to achieve a significant change because of the close relationship to developing capability, background smearing, and toner scattering.

Meanwhile, when the magnetic constriction force Fm is focused, it is expressed

Fm=KM(∂H/∂x)

where K is the mass of the carrier. And the following equation is established.

K=( 4/3)π·r³·ρ

where r is the radius of carrier, ρ is specific gravity of carrier, and M is the magnetization per unit of mass.

Also, the following represents the slope of the strength (H) of the magnetic field at the position where the carrier is present.

(∂H/∂x)

The magnetic constriction force (Fm) of the carrier is proportional to the cube of the carrier radius (r). Thus, as the particle size of carrier decreases, so too does the magnetic constriction force rapidly in proportion to the cube of the decrease in particle radius, and carrier adhesion becomes much more likely to occur.

In view of this, the inventors produced and examined samples of different carrier magnetization, and discovered that carrier adhesion can be reduced if the magnetization when a magnetic field of 1000 oersteds (Oe) has been applied is 50 emu/g or more, and preferably 70 emu/g or more. Also, from the standpoint of carrier adhesion, there is no particular upper limit to this, but about 150 emu/g usually becomes the upper limit, although magnetization that is too strong may impair the smoothness of the magnetic brush, and from the standpoint of higher image quality 100 emu/g or less is preferable.

If carrier adhesion occurs, it can cause scratching of the photoconductor drum or the fixing roller, which leads to a drop in image quality. If the magnetization of the carrier core particles is below the above range, a magnetic constriction force (Fm) of adequate strength will not be obtained, so carrier adhesion will be more likely to occur, and this is undesirable for practical purposes.

The above-mentioned magnetization can be measured as follows.

Using a B—H Tracer (BHU-60, made by Riken Denshi), a cylindrical cell is filled with 1.0 g of carrier core particles, and this cell is placed in the apparatus. The magnetic field is gradually increased to 3000 oersteds, and then gradually decreased to zero, after which a magnetic field with the opposite orientation is gradually increased to 3000 oersteds and then gradually decreased to zero. A BH curve is thus plotted, and magnetization of 1000 oersteds is calculated from this graph.

Examples of core particles that provide a magnetization of 50 emu/g or more when a magnetic field of 1000 oersteds is applied, and which are used in the carrier of the present invention, include ferromagnetic materials such as iron and cobalt, and magnetite, hematite, lithium ferrite, Mn—Zn ferrite, Cu—Zn ferrite, Ni—Zn ferrite, barium ferrite, and manganese ferrite.

A ferrite is a sintered material generally expressed by the following formula.

(MO)x(NO)y(Fe₂O₃)z

Where x+y+z=100 mol %, and M and N each a metal such as Ni, Cu, Zn, Li, Mg, Mn, Sr, or Ca, made up of a perfect mixture of divalent metal oxide and trivalent iron oxide.

Various heretofore known magnetic materials can be used as the material for the core particles that make up the carrier of the present invention, but as mentioned above, magnetite, Mn—Mg—Sr ferrite, manganese ferrite, and the like are examples of core particles that can be used favorably, whose magnetization is 70 emu/g or more when a magnetic field of 1000 oersteds has been applied.

There are no restrictions on the carrier resistivity in the present invention, but it is preferably 1×10¹¹ to 1×10¹⁶ (Ω·cm), and more preferably 1×10¹² to 1×10¹⁴ (Ω·cm).

If the carrier resistivity is lower than 1×10¹¹ (Ω·cm), then when the developing gap (the nearest distance between the photoconductor drum and the developing sleeve) is narrow, there will be a tendency for a charge to be induced in the carrier, and for carrier adhesion to occur. A worsening trend is seen when the linear velocity of the photoconductor drum and the linear velocity of the developing sleeve are high. This is more pronounced when an AC bias is applied. Usually, an adequate amount of toner adhesion is obtained with a carrier for color toner developing, so a material with low resistance is generally used.

A carrier whose resistance is within the above range will yield an adequate image density if used with a suitable amount of toner charge.

Also, if the resistivity is higher than 1×10¹⁶(Ω·cm), a charge with the opposite polarity from that of the toner will tend to accumulate, the carrier will become charged, and carrier adhesion will be more apt to occur.

The above-mentioned carrier resistivity can be measured by the following method.

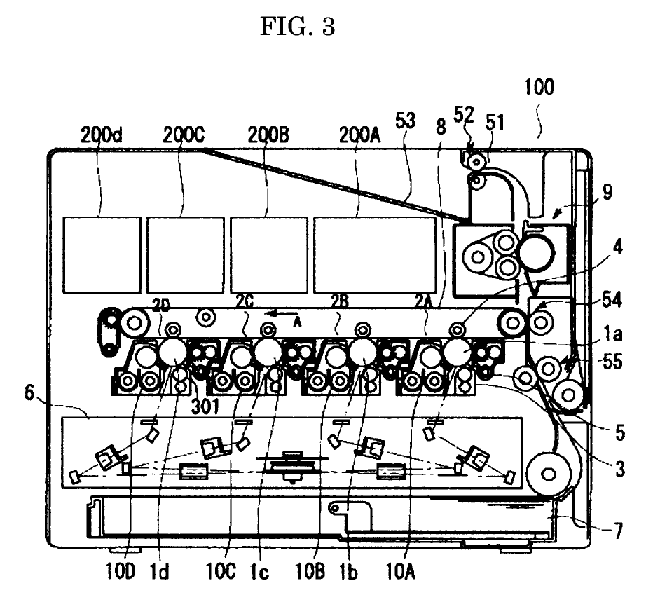

As shown in FIG. 2, a cell 21 comprising a container made of a fluororesin and containing electrodes 22a and 22b with an electrode spacing of 2 mm and a surface area of 2×4 cm is packed with carrier 23, a DC voltage of 100 V is applied between the electrodes, and the DC resistance is measured with a High Resistance Meter 4329A (4329A+LJK 5HVLVWDQFH OHWHU; made by Yokokawa Hewlett-Packard).

As to the degree to which the cell is packed in measurement of carrier resistance, the cell is filled to overflowing with carrier, then the entire cell is tamped 20 times, after which the top surface of the cell is scraped smooth in a single pass across the top end of the cell with a horizontal scraper made of a non-magnetic material. No pressure application is required while packing.

The resistivity of the carrier can be adjusted by controlling quantity of conductive microparticles, the thickness of the resin cover layer, and so forth.

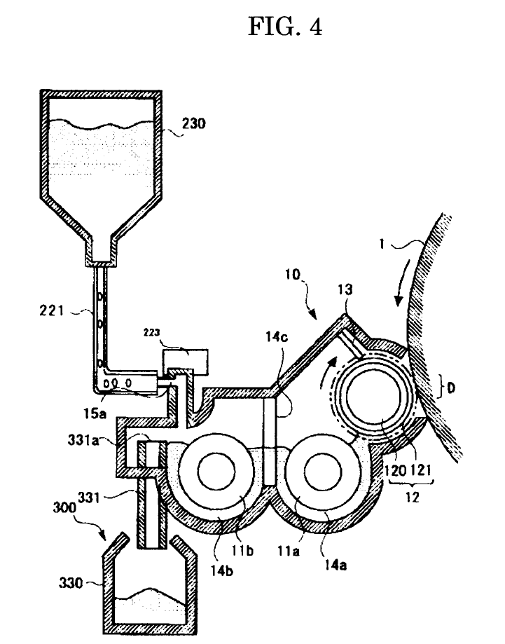

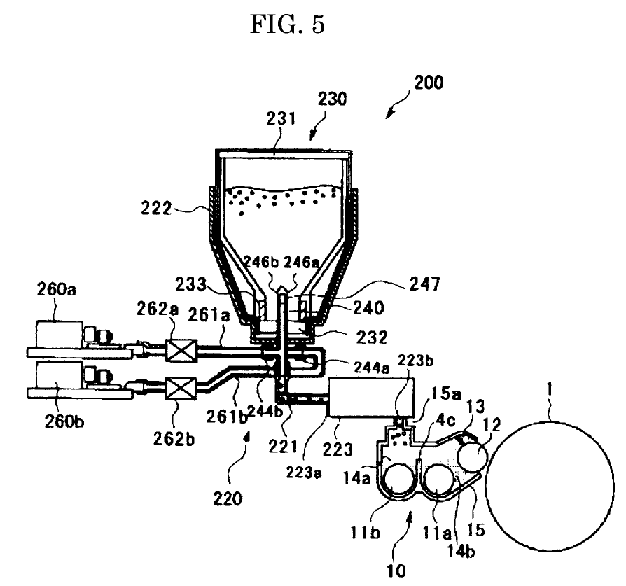

In an embodiment of the present invention, the carrier described in detail above (see FIG. 1), which includes the first particles G1 and the second particles G2 in the cover layer 27 that covers the surface of the core 26, is held in a developer container 230 (see FIG. 4). With an image forming apparatus 100 (see FIG. 3), a supply developer containing this carrier is supplied from inside the developer container 230 (see FIG. 4) into a developer container 14 (see FIG. 4).

In FIG. 4, the toner and carrier supplied into the developer container 14 are mixed along with the toner and carrier already held therein from the outset, by conveyance screws 11a and 11b. The toner and the carrier, or the carrier particles, come into contact with each other forcefully, and friction at these places makes shaving of the carrier surface particularly likely to occur.

However, the carrier contained in the developer of the present invention is such that some of the first particles G1 are present as protrusions over the cover layer 27. Accordingly, as discussed above, even if toner or other carrier particles come into contact with the cover layer 27 during stirring and mixing, the impact thereof will be softened by these protrusions on the surface of the cover layer 27. Therefore, the proportion of the carrier surface where shaving occurs can be greatly reduced.

Furthermore, the toner-spent component that adheres to the carrier surface during stirring is scraped off by the first particles present as these protrusions, so toner-spent is prevented from occurring. Also, the strength of the cover layer is increased by the second particles G2, so shaving itself is less likely to occur. This means that the developer in the developer container 14 maintain a more stable charge control effect for an extended period.

With the developing apparatus 10, most of the degraded carrier is discharged by a developer discharge apparatus 300.^{[5]} There is a slight possibility, however, that some of the degraded carrier will remain in the developer container 14 for an extended period, and if little toner is consumed in the image forming apparatus 100, not much of the carrier may be replaced in the developer container 14, and the carrier may stay in the developer container 14 for a long time.

In this embodiment, carrier that is the same as the carrier used for the supply developer is also used for the developer in the developing apparatus held in the developer container 14, from before the supply of the supply developer in the developer container 230. Therefore, when the amount of developer replacement is small, or when some of the carrier held inside from the outset remains without being discharged from the developer container 14, degradation of the carrier in the developer container 14 will be suppressed by the same mechanism as discussed above, allowing the chargeability of the developer to be kept stable even after extended use.

FIG. 3 is a schematic diagram illustrating the configuration of the image forming apparatus pertaining to an embodiment of the present invention.

Image forming units 2A, 2B, 2C, and 2D, which are four process cartridges having photoconductor drums 1 (image bearing members), are removably installed in the image forming apparatus 100. A transfer apparatus comprising a transfer belt 8 mounted rotatably in the arrow A direction between a plurality of rollers is disposed in the approximate center of the image forming apparatus 100.

Photoconductor drums 1, which are provided one each to the image forming units 2A, 2B, 2C, and 2D, are disposed in contact with the lower surface of the transfer belt 8. Developing apparatus 10A, 10B, 10C, and 10D that each make use of toner of a different color are disposed corresponding to the image forming units 2A, 2B, 2C, and 2D, respectively.

The image forming units 2A, 2B, 2C, and 2D are all configured the same, and the image forming unit 2A forms an image corresponding to the color magenta, the image forming unit 2B forms an image corresponding to color cyan, the image forming unit 2C forms an image corresponding to the color yellow, and the image forming unit 2D forms an image corresponding to the color black.

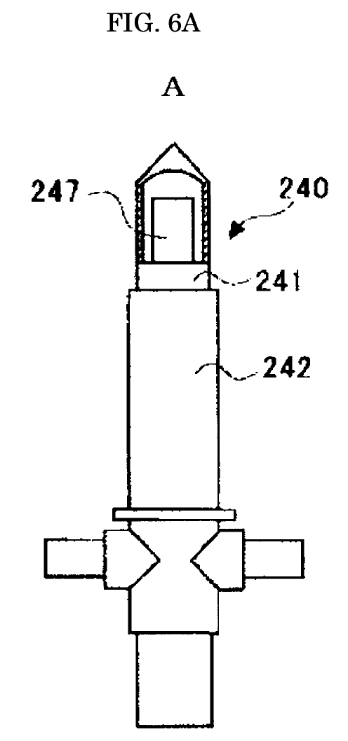

Two-component developers including toner and carrier are used in the developing apparatus 10A, 10B, 10C, and 10D disposed inside the image forming units 2A, 2B, 2C, and 2D, respectively, toner is supplied from developer supply apparatus 200 (discussed below; see FIG. 5) according to the output of a toner density sensor (not shown) provided to the developer container 14, and developing is performed by a system in which the carrier is also supplied, old developer is discharged, and the developer is replaced.

Developer supply apparatus 200A, 200B, 200C, and 200D are disposed in the spaces above the image forming units 2A, 2B, 2C, and 2D, respectively. The developer supply apparatus 200 are configured to supply fresh toner and fresh carrier to the developing apparatus 10, apart from the toner that is supplied to the photoconductor drums 1. This configuration is shown in FIG. 4. An exposure apparatus 6 is disposed as a write unit beneath the image forming units 2A, 2B, 2C, and 2D.

The exposure apparatus 6 comprises four light sources that make use of laser diodes (LD), one of which is readied for each color, a polygon scanner set made up of a six-face polygon mirror and a polygon motor, an fθ lens disposed in the optical path of each light source, and mirrors or lens such as long cylindrical lenses. The laser beams emitted from the laser diodes are polarized and scanned by the polygon scanner, and directed onto a photoconductor drum 5.

A fixing apparatus 9 that fixes an image that has been transferred onto paper is provided between the transfer belt 8 and the developer supply apparatus 200. A paper discharge path 51 is formed on the downstream side in the transfer paper conveyance direction of the fixing apparatus 9, and the transfer paper that has been conveyed there can be discharged into a paper discharge tray 53 by a pair of paper discharge rollers 52. A paper feed cassette 7 capable of holding transfer paper is installed at the bottom part of the image forming apparatus 100.

Next, the operation in image formation of this image forming apparatus 100 will be described. When the image formation operation is commenced, each photoconductor drum 1 rotates in the clockwise direction in FIG. 3. The surface of each photoconductor drum 1 is uniformly charged by a charging roller 301 of a charging unit 3. The exposure apparatus 6 directs a laser beam corresponding to a magenta image at the photoconductor drum 1a of the image forming apparatus 2A, a laser beam corresponding to a cyan image at the photoconductor drum 1b of the image forming apparatus 2B, a laser beam corresponding to a yellow image at the photoconductor drum 1c of the image forming apparatus 2C, and a laser beam corresponding to a black image at the photoconductor drum 1d of the image forming apparatus 2D, and latent electrostatic images corresponding to the image data of each color are formed. When the rotation of the photoconductor drums 1 brings the latent electrostatic images to the positions of the developing apparatus 10A, 10B, 10C, and 10D, the latent electrostatic images are developed there by magenta, cyan, yellow, and black toner, producing a four-color toner image.

Meanwhile, transfer paper is fed from the paper feed cassette 7 by a separating paper feeder, and is conveyed by a pair of resist rollers 55 provided directly in front of the transfer belt 8, at a timing that matches up with the toner images formed on the photoconductor drums 1. The transfer paper is charged to a positive polarity by a paper chucking roller 54 provided near the entrance to the transfer belt 8, which causes the paper to be electrostatically chucked to the surface of the transfer belt 8. Then, the transfer paper is conveyed while it is held to the transfer belt 8, while the magenta, cyan, yellow, and black toner images are successively transferred, forming a full-color toner image of four overlapping colors. Heat and pressure are applied to the transfer paper at the fixing apparatus 9, which fuses and fixes the toner images, after which the paper goes through the discharge system and is discharged into the paper discharge tray 53 at the top part of the image forming apparatus 100.

Next, the configuration around the developing apparatus will be described. FIG. 4 is a simplified cross section of the structure of the developing apparatus provided to the image forming apparatus of the present invention, and its surroundings. In FIG. 4, a developer supply apparatus 200 (see FIG. 5) that supplies fresh toner and carrier into the developing apparatus 10 is provided above the developing apparatus 10, and a developer discharge apparatus 300 that discharges excess developer from inside the developing apparatus 10 is provided below the developing apparatus 10.

The main components of the developing apparatus 10 are a housing 15 (see FIG. 5) having the developer container 14 that holds a two-component developer composed of toner and carrier; a developing roll 12 that serves as a developer support conveyor and is provided so as to rotate close to a photoconductor drum 1 that serves as an image bearing member, on the open side of the housing 15; two conveyance screws 11a and 11b that serve as developer stirring and conveyance members and are provided so as to rotate inside the developer container 14; and a layer thickness regulating member 13 provided either close to or pressed against the surface of the developing roll 12.

The developing roll 12 comprises a cylindrical sleeve 121 that is rotationally driven and a magnet roll 120 that is fixed on the inside. The developer container 14 is divided in two by a partition 14c in the middle, and comprises holding spaces 14a and 14b that communicate with each other by means of communicating components at both ends. The developer is conveyed back and forth between the holding spaces 14a and 14b while being stirred by the conveyance screws 11a and 11b rotating in the holding spaces 14a and 14b, respectively. The layer thickness regulating member 13 has a two-ply construction comprising a non-magnetic member and a magnetic member, and its distal end is disposed across from a specific magnetic pole of the magnet roll 120.

The developer supply apparatus 200 comprises a developer container 230 that holds a two-component supply developer, and a developer supplier 220 (see FIG. 5) that takes the two-component developer out of the developer container 230 and supplies it to the developer container 14. The developer supplier 220 is connected between the developer container 230 and the developing apparatus 10.

The configuration of the developer supply apparatus 200 will be described in detail through reference to FIG. 5.

The developer discharge apparatus 300 comprises a recovery container 330 for recovering excess two-component developer in the developer container 14, and a discharge pipe 331 that serves as a developer discharge means for sending developer that overflows from the developer container 14 to the recovery container 330. The discharge pipe 331 is provided so that its upper opening 331a is positioned at a specific height within the developer container 14, and discharges any developer that goes past the upper opening 331a at this specific height.

The developer discharge apparatus of the present invention is not limited to the above configuration. For example, a developer discharge opening may be made at a specific location in the housing 15, a conveyance member such as a discharge screw may be installed as a developer discharge means near the developer discharge outlet instead of the discharge pipe 331, and the developer discharged from the developer discharge outlet may be conveyed to the recovery container 330.

It is also possible to provide this discharge screw at the end or on the inside of the discharge pipe 331 of this embodiment.

Next, the developing operation of the developing apparatus will be described through reference to FIG. 4.

First, the developer in the developing apparatus held in advance in the developer container 14 is thoroughly stirred, mixed, and triboelectrically charged by the conveyance screws 11a and 11b, after which it is supplied to the developing roll 12, and adheres in the form of a layer to the surface of the sleeve 121 thereof.

The layer of developer adhering to the developing roll 12 is adjusted to a specific thickness by the layer thickness regulating member 13 and thereby made into a uniform layer, after which it is conveyed to a developing region D across from the photoconductor drums 1 by the rotation of the sleeve 121. In this developing region D, developing is performed in which the toner of the two-component developer is electrostatically affixed to the latent electrostatic images formed on the photoconductor drums 1 according to the image on the original, on the image forming apparatus 100 side (see FIG. 3). This forms toner images on the photoconductor drums 1.

The toner images formed on the photoconductor drums 1 are transferred onto recording paper on the image forming apparatus 100 side, and fixed on the recording paper by a fixing component.

As this developing operation is repeated, the toner contained in the developer inside the developing apparatus in the developer container 14 is consumed and gradually depleted, but when the amount of toner depletion is detected by the above-mentioned toner density sensor, the developer supplier 220 of the developer supply apparatus 200 is driven. This causes the supply developer containing toner and carrier (discussed in detail below) and held in a developer bearing member 231 of the developer container 230 to be supplied. The fresh two-component developer supplied to the developer container 14 is stirred by the conveyance screws 11a and 11b inside the developer container 14, and is thoroughly mixed with the developer in the developing apparatus held since before supply.

The supply of developer from the developer supply apparatus 200 into the developer container 14 results in the carrier also being supplied in a specific proportion along with the toner, so the amount of developer in the developer container 14 steadily becomes an excess. The excess two-component developer in the developer container 14 goes above the height limit in the container 14 and overflows, then goes through the discharge pipe 331 of the developer discharge apparatus 300 and is held in the recovery container 330.

The “supply developer” in the present invention includes at least toner and carrier. The toner discussed below can be used as the toner of the supply developer held in the developer container 230, and as shown in FIG. 1 it is possible to use as the carrier thereof a magnetic carrier in which a cover layer 27 having specific particles is formed on a core 26.

The toner of the developer in the developing apparatus can be either the same as the toner held in the developer container 230, or it can be a different toner, and the carrier can also be the same as the carrier held in the developer container 230, or it can be a different carrier.

The weight ratio of the carrier in the developer held in the developing apparatus is preferably 85 wt % or more and less than 98 wt %. If the carrier weight ratio is less than 85 wt %, the toner proportion will be too high, so an adequate charge can no longer be imparted to the toner. This also leads to toner scatter and fouling inside the machinery. If the weight ratio of the carrier is 98 wt % or more, the carrier proportion will be too high, so there will be a higher probability of impact between carrier particles within the developing apparatus, which is disadvantageous to durability. Also, the charge amount will be too high, making it difficult to obtain a suitable image density.

As shown in FIG. 5, the image forming apparatus 100 in this embodiment is equipped with a developer supply apparatus 200 with which a developer bearing member 231 that has a readily deformable shape is packed with supply developer, and this supply developer is drawn in by a screw pump 223 and supplied to the developing apparatus 10.

The configuration of the developer supply apparatus 200 will now be described in detail through reference to FIGS. 5 to 9.

FIG. 5 is a simplified structural diagram of the developer supply apparatus 200 used in the present invention. The developer bearing member 231 is provided as a pouch-like member whose volume can be reduced, and is installed in the developer container 230 provided to the developer supply apparatus 200. The fresh supply developer supplied to the developer container 14 of the developing apparatus 10 is held in the developer bearing member 231. The developer bearing member 231 decreases in volume as the internal pressure drops through the supply of developer to the developer container 14.

The developer supplier 220 comprises the screw pump 223 that is linked to the upper end of a supply port 15a made in a specific location of the housing 15, a nozzle 240 connected to the screw pump 223, and an air supply means 260 connected to the nozzle 240, is driven according to detection signals from a toner density sensor (not shown) or the like installed in the developer container 14, and supplies the proper amount of developer from the developer container 230 to the developer container 14.

In between the screw pump 223 and the nozzle 240 there is a conveyance tube 221 serving as a developer conveyance path that communicates with the screw pump 223. This conveyance tube 221 is preferably made from a rubber material that is flexible and has excellent toner resistance, such as polyurethane, nitrile, or EPDM. The developer supply apparatus 200 has a container holder 222 for supporting the developer container 230 that serves as the developer container. This container holder 222 is made from a resin or other such material with high rigidity.

The developer container 230 has the developer bearing member 231 serving as a pouch-like formed from a pliant sheet material, and a base component 232 serving as a discharge portion formation member that forms a developer discharge port.

There are no particular restrictions on the material of the developer bearing member 231, and any material that can realize dimensional precision can be used to advantage. Favorable examples include polyester resin, polyethylene resin, polypropylene resin, polystyrene resin, polyvinyl chloride resin, polyacrylic resin, polycarbonate resin, ABS resin, polyacetal resin, and other such resins.

The base component 232 is provided with a seal 233 formed from a sponge, rubber, or the like, and a cross-shaped cut is made in this seal 233. The nozzle 240 of the developer supplier 220 is passed through this cut so that the developer container 230 and the developer supplier 220 communicate and are fixed.

In this embodiment, the base component 232 is provided below the developer container 230. The state of the base component 232 being provided below as referred to here means that in a state in which the developer container 230 has been installed in the developer supply apparatus 200, the base component 232 is provided at a location including the vertical component in the up and down direction of the developer container 230.

The location where the base component 232 is provided to the developer container main body is not limited to this, and in a state in which the developer container 230 has been installed in the developer supply apparatus 200, the base component 232 may be provided in the horizontal direction of the developer container 230 main body, or may be provided at an incline.

The developer container is replaced with a fresh one as the toner is consumed, and because the developer container 230 of this embodiment has the configuration described above, it can be easily installed and removed, and toner leakage can be prevented during replacement and use.

There are no particular restrictions on the size, shape, structure, material, and so forth of the developer bearing member 231, which can be suitably selected according to the intended use.

The shape of the developer bearing member 231 is preferably the above-mentioned cylindrical shape or the like, and spiral texturing is preferably formed around the inner peripheral surface thereof. The effect of forming this texturing is that when the developer container 230 is rotated, the toner held in the bearing member 231 can be moved smoothly to the discharge port side. Also, it is particularly favorable for some or all of the above-mentioned spiral component to have a bellows function.

The developer container 230 of the present invention can be easily installed in and removed from the developer supply apparatus 200 of the image forming apparatus 100, and it is easy to store and transport, giving it excellent handling properties.

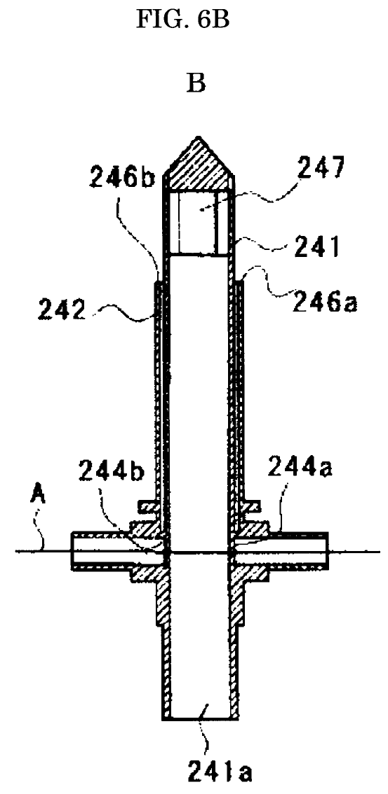

FIG. 6A is a diagram illustrating the simplified structure of the nozzle 240 provided to the developer supplier 220, FIG. 6B is a cross section in the axial direction thereof, and FIG. 6C is a cross section along the A-A line in FIG. 6B. As shown in FIG. 6B, this nozzle 240 has a two-ply construction comprising an inner pipe 241 and an outer pipe 242 that holds this inner pipe 241 on its inside. The inside of the inner pipe 241 is a developer channel 241a that serves as a developer conveyance path for discharging the developer from inside the developer container 230. The toner inside the developer container 230 is drawn up by the suction of the screw pump 223, passes through the developer channel 241a, and is drawn into the screw pump 223.

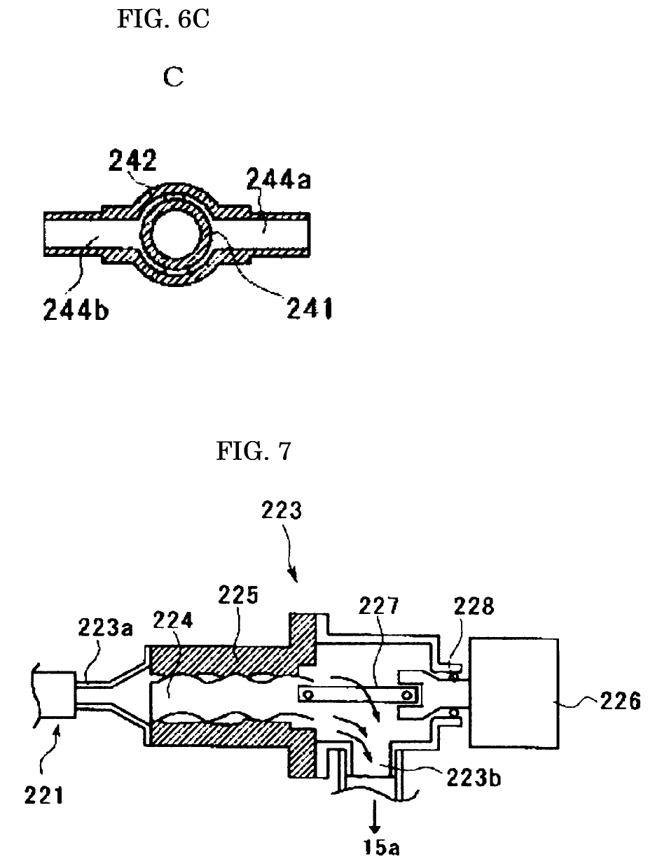

FIG. 7 is a cross section of the simplified structure of the screw pump 223. This screw pump 223 is called a uniaxial eccentric screw pump, and comprises on its inside a rotor 224 and a stator 225. The rotor 224 has a shape such that a circular cross section is twisted in a spiral, is made from a hard material, and is fitted inside the stator 225. The stator 225, meanwhile, is made from a soft rubber-like material and has a hole with a shape such that an elliptical cross section is twisted in a spiral, and the rotor 224 is fitted in this hole. The spiral pitch of the stator 225 is two times the spiral pitch of the rotor 224. Also, the rotor 224 is connected, via a universal joint 227 and a bearing 228, to a drive motor 226 for rotationally driving the rotor 224.

With this configuration, the toner and carrier that have been conveyed from the developer container 230 through the conveyance tube 221 and the developer channel 241a of the nozzle 240 go in through a toner intake port 223a of the screw pump 223. They then enter the space formed between the rotor 224 and the stator 225, and are drawn and conveyed by the rotation of the rotor 224 to the right in FIG. 5. The toner that has passed through the space between the rotor 224 and the stator 225 drops down through a toner drop port 223b, and is supplied through the developer supply port 14 of the developing apparatus 10 to the inside of the developing apparatus 10.

Also, as shown in FIG. 5, the developer supplier 220 used in this embodiment is equipped with air supply means 260 (260a and 260b) for supplying air into the developer container 230.

As shown in FIG. 5, air channels 244a and 244b are connected, respectively, via air supply paths 261a and 261b (serving as air supply passages) to air pumps 260a and 260b (serving as another air feed apparatus).

As shown in FIG. 6B, the air channels 244 are provided as air supply passages in between the inner pipe 241 and outer pipe 242 of the nozzle 240 of the developer supplier 220, and as shown in FIG. 6C, these air channels 244 ^{[10]} are made up of two mutually independent channels 244a and 244b with a semicircular cross sectional shape.

An ordinary diaphragm type air pump can also be used as the air pumps 260a and 260b. The air sent out from these air pumps 260a and 260b passes through the air channels 244a and 244b, respectively, and is supplied into the developer container 230 through air supply ports 246a and 246b serving as gas supply ports for the air channels. The air supply ports 246a and 246b are located below (in the drawing) a toner outflow port 247 serving as a developer discharge port of the toner channel 241a. As a result, the air supplied from the air supply ports 246a and 246b is supplied to the toner near the toner outflow port 247, so even if toner should be left unused for a long time and clog up the toner outflow port 247, the toner blocking this toner outflow port 247 can be broken up.

The air supply paths 261a and 261b are provided with shutoff valves 262a and 262b serving as blocking means that open and close according to control signals from a control component serving as an air feed control means (not shown). The shutoff valves 262a and 262b open and allow air to pass through when an ON signal is received from the control component, and close and prevent the passage of air upon receiving an OFF signal from the control component.

The operation of the developer supplier 220 in this embodiment will now be described through reference to FIG. 5.

The above-mentioned control component commences the developer supply operation upon receiving a signal indicating that toner density is too low from the developing apparatus 10. In this developer supply operation, first the air pumps 260a and 260b are driven to supply air into the developer container 230, and the drive motor 226 of the screw pump 223 is driven to draw in and convey the developer.

When air is sent out from the air pumps 260a and 260b, it enters the air independent channels 244a and 244b of the nozzle 240 from the air supply paths 261a and 261b, and is supplied from the air supply ports 246a and 246b to the developer container 230. This air agitates the developer in the developer container 230, causing it to contain a large amount of air, and this promotes fluidization.

Also, when air is supplied into the developer container 230, the internal pressure of the developer container 230 rises. Therefore, a differential is produced between the internal pressure of the developer container 230 and the external pressure (atmospheric pressure), and the fluidized developer is subjected to a force that moves it in the direction in which the pressure is exerted. This causes the developer in the developer container 230 to flow out in the direction in which the pressure is exerted, that is, from the toner outflow port 247.

With this embodiment, the suction force produced by the screw pump 223 also acts to cause the developer in the developer container 230 to flow out from the toner outflow port 247.

The developer that has flowed out from the developer container 230 as discussed above passes from the toner outflow port 247 and through the developer channel 241a of the nozzle 240, and then moves through the conveyance tube 221 into the screw pump 223. After it has moved through the screw pump 223, the developer drops down from the toner drop port 223b, and the developing apparatus 10 is supplied with developer from the developer container 14. Once a specific amount of developer has been supplied, the control component halts the drive of the air pumps 260a and 260b and the drive motor 226, closes the shutoff valves 262a and 262b, and concludes the toner supply operation. Thus closing the shutoff valves 262a and 262b upon conclusion of the toner supply operation prevents the toner in the developer container 230 from back-flowing toward the air pumps 260a and 260b through the air supply paths 244a and 244b of the nozzle 240.

The amount of air supplied from the air pumps 260a and 260b is set to be smaller than the amount of toner and air suction by the screw pump 223. Thus, as the toner is consumed, the internal pressure of the developer container 230 decreases. Since the developer bearing member 231 of the developer container 230 in this embodiment is formed from a flexible sheet material, its volume decreases along with the internal pressure.

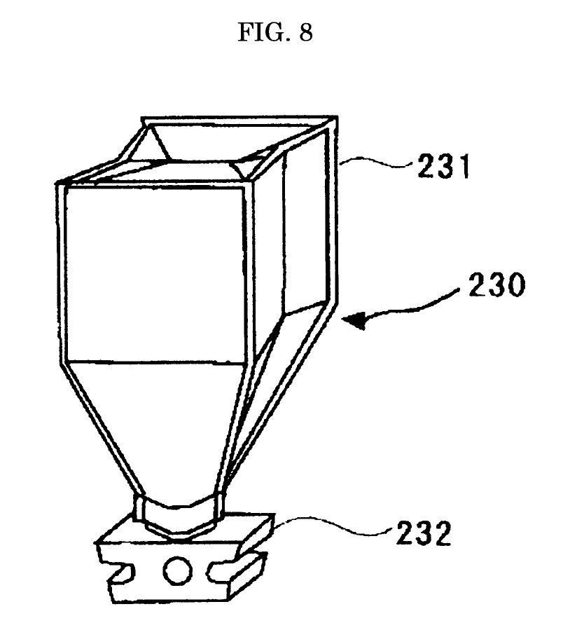

FIG. 8 is a perspective view of the state where the developer bearing member 231 has been filled with developer.

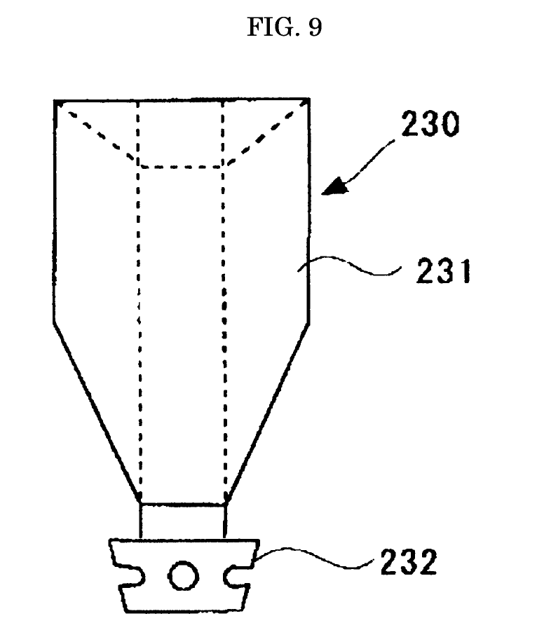

FIG. 9 is a front view of the state where the developer has been 20 discharged from the inside of the developer bearing member 231, reducing the volume (deflating it). It is preferable here for the volume of the developer bearing member 231 to be reduced by 60% or more.

The interior of the developer bearing member 231 of the developer container 230 shown in FIG. 8 holds a supply developer composed of carrier and toner, for supplying the developing apparatus 10. The supply developer is preferably such that the weight ratio of carrier in the supply developer is 3 wt % or more and less than 30 wt %.

If the weight ratio of the carrier in the supply developer in the developer container 230 is less than 3 wt %, the amount of carrier that is supplied will be extremely small, so the effect of supplying will not be sufficient. If the amount is over 30 wt %, though, the supply developer will not be stably supplied to the developer container.

The toner included in the supply developer and in the developer inside the developing apparatus contains at least a binder resin and a colorant, but may further contain a releasing agent, a charge control agent, or other components as needed.

The manufacture of the toner is not limited to any one particular method, and the method can be suitably selected according to the intended purpose. Examples include pulverization, a method in which toner base particles are formed by emulsifying, suspending, or agglomerating the oil phase in an aqueous medium, suspension polymerization, emulsion polymerization, polymer suspension, and other such methods.

There are no particular restrictions on the binder resin used for the toner in the present invention, and it can be suitably selected from among known binder resins according to the intended purpose, but examples include polystyrene, poly-p-styrene, polyvinyltoluene, and other such homopolymers of styrene and its derivatives; a styrene-p-chlorostyrene copolymer, styrene-propylene copolymer, styrene-vinyltoluene copolymer, styrene-methyl acrylate copolymer, styrene-ethyl acrylate copolymer, styrene-methacrylic acid copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ether copolymer, styrene-vinyl methyl ketone copolymer, styrene-butadiene copolymer, styrene-isopropyl copolymer, styrene-maleic acid ester copolymer, and other such styrene copolymers; and polymethyl methacrylate resin, polybutyl methacrylate resin, polyvinyl chloride resin, polyvinyl acetate resin, polyethylene resin, polyester resin, polyurethane resin, epoxy resin, polyvinyl butyral resin, polyacrylic acid resin, rosin resin, modified rosin resin, terpene resin, phenol resin, aliphatic or aromatic hydrocarbon resin, aromatic petroleum resin, and so forth, either along or as a mixture.

There are no particular restrictions on the colorant, which can be suitably selected from among known dyes and pigments according to the intended purpose, but examples include carbon black, nigrosine dyes, black iron oxide, naphthol yellow S, Hansa Yellow 10G, 5G, and G, Cadmium Yellow, yellow iron oxide, loess, chrome yellow, Titan Yellow, polyazo yellow, oil yellow, Hansa Yellow GR, A, RN, and R, Pigment Yellow L, Benzidine Yellow G and GR, Permanent Yellow NCG, Vulcan Fast Yellow 5G and R, Tartrazine Lake, Quinoline Yellow Lake, Anthrazane Yellow BGL, Isoindolinone Yellow, red iron oxide, red lead, orange lead, cadmium red, cadmium mercury red, antimony orange, Permanent Red 4R, Para Red, Fire Red, ^{[6]} para-chloro-ortho-nitroaniline red, Lithol Fast Scarlet G, Brilliant Fast Scarlet, Brilliant Carmine BS, Permanent Red F2R, F4R, FRL, FRLL, and F4RH, Fast Scarlet VD, Vulcan Fast Rubine B, Brilliant Scarlet G, Lithol Rubine GX, Permanent Red F5R, Brilliant Carmine 6B, Pigment ^{[7]} Scarlet 3B, Bordeaux 5B, Toluidine Maroon, Permanent Bordeaux F2K, Hello Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, Polyazo Red, Chrome Vermilion, Benzidine Orange, Perynone Orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue RS and BC, indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. These materials may be used alone or in combination. The content of the colorant in the toner is preferably from 1 wt % to 15 wt %, and more preferably from 3 wt % to 10 wt %.

The colorant may be used as a master batch that is compounded with a resin. There are no particular restrictions on the resin here, which can be suitably selected from among known resins according to the intended purpose, but examples include styrene polymers and substituted styrene polymers, styrene copolymers, polymethyl methacrylate resin, polybutyl methacrylate resin, polyvinyl chloride resin, polyvinyl acetate resin, polyethylene resin, polypropylene resin, polyester resin, epoxy resin, epoxy polyol resin, polyurethane, polyamide, polyvinyl butyral, polyacrylic acid resin, rosin, modified rosin, terpene resin, aliphatic hydrocarbon resin, alicyclic hydrocarbon resin, aromatic petroleum resin, chlorinated paraffin, and paraffin. These may be used alone or in combination.

There are no particular restrictions on the releasing agent, which can be suitably selected from among known releasing agents according to the intended purpose, but favorable examples include waxes and so on.

Examples of waxes include waxes including a carbonyl group, polyolefin waxes, and long-chain hydrocarbons. These may be used alone, or two or more may be combined. Of these, a wax that includes a carbonyl group is preferred.

Examples of waxes that include a carbonyl group include polyalkane acid esters, polyalkanol esters, polyalkane acid amides, polyalkylamides, and dialkyl ketones. Examples of polyalkane acid esters include carnauba wax, montan waxes, trimethylolpropane tribehenate, pentaerythritol tetrabehenate, pentaerythritol diacetate dibehenate, glycerol tribehenate, and 1,18-octadecanediol distearate. Examples of polyalkanol esters include tristearyl trimellitate and distearyl maleate. Examples of polyalkane acid amides include dibehenylamide. Examples of polyalkylamides include trimellitic acid tristearylamide. Examples of dialkyl ketones include distearyl ketone. Of these waxes that include a carbonyl group, a polyalkane acid ester is particular favorable. Examples of polyolefin waxes include polyethylene wax and polypropylene wax. Examples of long-chain hydrocarbons include paraffin wax and Sazol waxes.

There are no particular restrictions on the melting point of the releasing agent, which can be suitably selected according to the intended purpose, but from 40° C. to 160° C. is preferable, from 50° C. to 120° C. is more preferable, and from 60° C. to 90° C. is particularly favorable.

If the melting point is below 40° C., the wax will have an adverse effect on heat resistance and storage stability, but the melting point is over 160° C., cold offset will be more likely to occur during fixing at low temperatures.

The releasing agent preferably has a melt viscosity of from 5 cps to 1000 cps, and more preferably from 10 cps to 100 cps, as measured at a temperature 20° C. higher than the melting point of the wax. If the melt viscosity is less than 5 cps, partability may decrease, but if it is over 1000 cps, the effect of improving hot offset resistance and low temperature fixability may be diminished.

There are no particular restrictions on the content of the releasing agent in the toner, which can be suitably selected according to the intended purpose, but is preferably from 1 wt % to 40 wt %, and more preferably from 3 wt % to 30 wt %. If this content is over 40 wt %, the fluidity of the toner may suffer.

There are no particular restrictions on the charge control agent, and a positive or negative charge control agent can be suitably selected according to whether the photoconductor drum is charged positively or negatively.

Examples of negative charge control agents that can be used include metal complexes of organic acids, azo dyes, and compounds or resins having electron-donating functional groups. Specific examples include Bontron (product numbers S-31, S-32, S-34, S-36, S-37, S-39, S-40, S-44, E-81, E-82, E-84, E-86, E-88, A, 1-A, 2-A, and 3-A) (the above are made by Orient Chemical Industries); Kayacharge (product numbers N-1 and N-2) and Kayaset Black (product numbers T-2 and 004) (the above are made by Nippon Kayaku); Aizen Spiron Black (product numbers T-37, T-77, T-95, TRH, and TNS-2) (the above are made by Hodogaya Chemical); and FCA-1001-N, FCA-1001-NB, and FCA-1001-NZ (which are made by Fujikura Kasei).

Examples of positive charge control agents include basic compounds such as nigrosine dyes, cationic compounds such as quaternary ammonium salts, and metal salts of higher fatty acids. Specific examples include Bontron (product numbers N-01, N-02, N-03, N-04, N-05, N-07, N-09, N-10, N-11, N-13, P-51, P-52, and AFP-B) (which are made by Orient Chemical); TP-302, TP-415, and TP-4040 (which are made by Hodogaya Chemical); Copy Blue PR and Copy Charge (product numbers PX-VP-435 and NX-VP-434) (the above are made by Hoechst); FCA (product numbers 201, 201-B-1, 201-B-2, 201-B-3, 201-PB, 201-PZ, and 301 (which are made by Fujikura Kasei); and PLZ (product numbers 1001, 2001, 6001, and 7001) (which are made by Shikoku Chemicals). These may be used alone or in combination.

The amount in which the charge control agent is added is determined by the type of binder resin and by the toner manufacturing method (including the dispersion method), and as such cannot be unconditionally specified, but is preferably from 0.1 parts by weight to 10 parts by weight, and more preferably from 0.2 parts by weight to 5 parts by weight, per 100 parts by weight binder resin. If the added amount is over 10 parts by weight, the toner chargeability will be too high, which diminishes the effect of the charge control agent, increases the electrostatic attraction force of the developing roller, and may lead to a decrease in the fluidity of the developer or in the image density, but if the amount is less than 0.1 parts by weight, charging rise and the charge amount will be unsatisfactory, and this will tend to have an adverse effect on the toner image.

In addition to the binder resin, releasing agent, colorant, and charge control agent, the toner material can also contain as needed inorganic microparticles, a fluidity enhancer, a cleaning enhancer, a magnetic material, metallic soap, or the like.

Examples of inorganic microparticles that can be used include silica, titania, alumina, cerium oxide, strontium titanate, calcium carbonate, magnesium carbonate, and calcium silicate. It is preferable to use silica microparticles that have undergone a hydrophobic treatment with silicone oil or hexamethyldisilazane, or titanium oxide that has undergone a specific surface treatment.

Examples of the above-mentioned silica microparticles include Aerosil (product numbers 130, 200V, 200CF, 300, 300CF, 380, OX50, TT600, MOX80, MOX170, COK84, RX200, RY200, R972, R974, R976, R805, R811, R812, T805, R202, VT222, RX170, RXC, RA200, RA200H, RA200HS, RM50, RY200, and REA200) (the above are made by Nippon Aerosil); HDK (product numbers H20, H2000, H3004, H2000/4, H2050EP, H2015EP, H3050EP, and KHD50) and HVK2150 (the above are made by Wacker Chemicals); and Cabosil (product numbers L-90, LM-130, LM-150, M-5, PTG, MS-55, H-5, HS-5, EH-5, LM-150D, M-7D, MS-75D, TS-720, TS-610, and TS-530) (the above are made by Cabot).

The amount in which the inorganic microparticles are added is preferably 0.1 parts by weight to 5.0 parts by weight, and more preferably 0.5 parts by weight to 3.2 parts by weight, per 100 parts by weight of the toner base particles.

As mentioned above, there are no particular restrictions on the method for manufacturing the toner in the present invention, but the following is an example of powder manufacturing method.

The above-mentioned toner materials are mixed, and this mixture is supplied to a melt kneader. This melt kneader can be a uniaxial or biaxial continuous kneader, or a batch kneader featuring a roll mill. For example, a model KTK biaxial extruder made by Kobe Steel, a model TEM biaxial extruder made by Toshiba Machine, a biaxial extruder made by KCK, a model PCM biaxial extruder made by Ikegai, or a co-kneader made by BUSS can be used to advantage. This melt kneading is preferably conducted under appropriate conditions that will not lead to the breaking of molecular chains in the binder resin. Specifically, the melt kneading temperature is set after taking into account the softening point of the binder resin. If the temperature is too much higher than the softening point, there will be severe chain breakage, but if the temperature is too low, dispersion may not proceed.

With pulverization, the kneaded material obtained above is pulverized. In this pulverization, first the kneaded material preferably is coarsely ground, and then finely pulverized. It is favorable to employ a method in which the pulverization is accomplished by colliding the material with an impact place in a jet flow, or by colliding the particles together in a jet flow, or by pulverizing in a narrow gap between a mechanically rotated rotor and a stator.

The pulverized product obtained by the above-mentioned pulverization is graded to adjust the particles to a specific size. This grading can be performed by removing microparticles using, for example, a cyclone, a decanter, a centrifugal separator, or the like.

When the pulverization and grading have been completed, the pulverized material is graded in an airflow by centrifugal force or the like to produce a toner of a specific particle size.

To improve the fluidity, storage stability, developing property, and transfer property of the toner, inorganic microparticles such as a hydrophobic silica fine powder may be further added and mixed into the toner base particles produced as above. Any standard powder mixer can be used to mix the additives, but the mixer is preferably equipped with a jacket or the like to adjust the internal temperature. To change load history imparted to the additives, the additives may be added in the course of mixing or gradually. In this case, the rotational speed, tumbling rate, duration, temperature and other such factors may be varied. Alternatively, a high load may be applied initially, and then a relatively weak load may be applied, or vice versa. Examples of mixing equipment that can be used a V-mixer, a rocking mixer, a Loedige mixer, a Nauta mixer, and a Henschel mixer. This product is then sifted to remove coarse particles and agglomerated particles and to obtain a toner.

In this embodiment, a developer that includes the above-mentioned carrier and toner is used in the image forming apparatus shown in FIG. 3 as the supply developer and the developer in the developing apparatus, and this prevents the occurrence of toner-spent on the carrier surface and the shaving of the carrier surface even after extended use, which minimizes the decrease in the electrical resistance of the carrier and the decrease in the amount of charge of the developer in the developer container 14, and allows stable developing characteristics to be obtained.

Particles provided with a conductive cover layer composed of tin dioxide and indium oxide are used as conductive particles in the carrier used in this embodiment, which prevents color fouling and also allows for effective control towards lowering resistance, and as a result, there is no need to use the carbon black that is the source of color fouling, and resistance can be adjusted, so stable chargeability can be maintained, and even in use in a color image forming apparatus, there will be no color fouling on the image, and a high-quality color image can be obtained with good color reproduction and high fineness.

The configuration of the image forming apparatus used in the present invention is not limited to what has been described above in this embodiment, and as long as it has the same function, an image forming apparatus having another configuration can also be used.

### EXAMPLES

The present invention will now be described through Examples and comparative examples, but the present invention is not limited to the examples given here. All references to “parts” below indicate “parts by weight,” while “%” indicates % by weight or wt %.

### (Production of Toner)

### Binder Resin Synthesis Example 1

724 parts of a 2-mole ethylene oxide adduct of bisphenol A, 276 parts of isophthalic acid, and 2 parts of dibutyl tin oxide were put in a reaction vessel equipped with a condenser tube, a stirrer, and a nitrogen introduction tube, and a reaction was conducted under normal pressure for 8 hours at 230° C. The reaction was allowed to proceed for another 5 hours under a reduced pressure of 10 mmHg to 15 mmHg, after which the system was cooled 160° C., 32 parts of phthalic anhydride was added, and the reaction was conducted for another 2 hours. The system was then cooled to 80° C. and allowed to react for 2 hours with 188 parts of isophorone diisocyanate in ethyl acetate, which gave a prepolymer P1 containing an isocyanate.

267 parts of the prepolymer P1 and 14 parts of isophoronediamine were then reacted for 2 hours at 50° C., which gave a urea-modified polyester U1 with a weight average molecular weight of 64,000.

In the same manner as above, 724 parts of a 2-mole ethylene oxide adduct of bisphenol A and 276 parts of isophthalic acid were subjected to polycondensation for 8 hours at 230° C. and under normal pressure, and then reacted for 5 hours under a reduced pressure of 10 mmHg to 15 mmHg, which gave an unmodified polyester E1 with a peak molecular weight of 5000.

200 parts of the urea-modified polyester U1 and 800 parts of the unmodified polyester E1 were melted and mixed in 2000 parts of an ethyl acetate/MEK (1/1) mixed solvent, which gave an ethyl acetate/MEK solution of a binder resin B1.

Part of this product was dried under reduced pressure to isolate the binder resin B1. The Tg was 62° C.

### Polyester Resin Synthesis Example A

| | |
|---|---|
| terephthalic acid | 60 parts |
| dodecenyl succinic anhydride | 25 parts |
| trimellitic anhydride | 15 parts |
| bisphenol A (2,2) propylene oxide | 70 parts |
| bisphenol A (2,2) ethylene oxide | 50 parts |

The above composition was put into a four-neck round-bottom flask with a volume of 1 L and equipped with a thermometer, a stirrer, a condenser, and a nitrogen gas introduction tube. This flask was placed in a mantle heater, nitrogen gas was introduced through the nitrogen gas introduction tube, the temperature was raised with the inside of the flask maintained under this inert atmosphere, and then 0.05 g of dibutyltin oxide was added and a reaction was conducted with the temperature held at 200° C., which gave a polyester A. This polyester A had a peak molecular weight of 4,200, and its glass transition point was 59.4° C.

### Master Batch Production Example 1

| | |
|---|---|
| pigment (C.I. Pigment Yellow 155) | 40 parts |
| binder resin (polyester resin A) | 60 parts |
| water | 30 parts |

The above raw materials were mixed in a Henschel mixer, which gave a mixture in the form of a pigment agglomeration soaked with water. This was kneaded for 45 minutes with a twin roll set to a surface temperature of 130° C., then pulverized to a diameter of 1 mm to obtain a master batch M1.

### Toner Manufacturing Example A

240 parts of an ethyl acetate/MEK solution of the above-mentioned binder resin B1, 20 parts of pentaerythritol tetrabehenate (melting point of 81° C., melt viscosity of 25 cps), and 8 parts of the master back M1 were put in a beaker, stirred at 12,000 rpm at 60° C. in a TK homomixer, and uniformly dissolved and dispersed to prepare a toner material liquid.

706 parts of deionized water, 294 parts of a 10% suspension of hydroxyapatite (Supatite 10 made by Nippon Chemical Industries), and 0.2 parts of sodium dodecylbenzenesulfonate were added to the beaker and uniformly dissolved.

The temperature was then raised to 60° C., and the system was stirred at 12,000 rpm with a TK homomixer while the above-mentioned toner material solution was added, and this was stirred for 10 minutes.

This liquid mixture was then transferred to a conical flask equipped with a stirring rod and a thermometer, the temperature was raised to 98° C. to remove the solvent, the remainder was filtered, and the filtrate was washed and dried, then graded with forced air to obtain toner particles.

1.0 part hydrophobic silica and 1.0 part hydrophobic titanium oxide were then mixed with 100 parts of these toner particles in a Henschel mixer to obtain a toner A.

An ultrathin slice of this toner A was produced, and a cross section of the toner (×100,000 magnification) was observed under a transmission electron microscope (H-9000H made by Hitachi). This micrograph was used to find an average value from the dispersion diameter of the colorant portion at 100 randomly selected points. Here, the dispersion diameter of one particle was the average of the major and minor diameters, and if the particles were in an agglomerated state, then the agglomerate itself was considered to a single particle.

The average dispersion particle diameter of the colorant was 0.40 μm. 4.5% of the colorant had a dispersion particle diameter of 0.7 μm or more.

Next, the particle diameter of the toner A was measured using a “Coulter Counter TA-2” particle size measurement gauge made by Coulter Electronics, at an aperture diameter of 100 μm, which revealed the volumetric average particle diameter Dv to be 6.2 μm and the number average particle diameter Dn to be 5.1 μm.

The circularity of the toner A was then measured as the average circularity with an FPIA-1000 flow-type particle image analyzer made by Toa Medical Electronics. For this measurement, 0.1 mL to 0.5 mL of a surfactant (alkyl benzenesulfonate; used as a dispersant) was added to 100 mL to 150 mL of water from which solid impurities had been removed, in the above-mentioned apparatus, then 0.1 g to 0.5 g of measurement sample was added, a dispersion treatment was performed for about 1 minute to 3 minutes with an ultrasonic disperser, the dispersion concentration was adjusted to between 3,000 and 10,000 particles per microliter, and this was used as the measurement liquid. The circularity of the resulting toner A was 0.96.

### Carrier Manufacturing Example

### Manufacturing Example 1

| | | |
|---|---|---|
| acrylic resin solution | 2,130 | parts |
| (solids concentration: 50 wt %) | | |
| aminosilane (solids concentration: 100 wt %) | 4 | parts |
| silica microparticles | 1,500 | parts |
| (volumetric average diameter: 0.07 μm) | | |
| toluene | 6,000 | parts |

The above materials were dispersed for 10 minutes in a homomixer to prepare a resin layer formation solution. The core a in Table 1 was used as a carrier core, which was coated with the above-mentioned resin solution at a rate of 30 g/min in a 55° C. atmosphere with a spin coater (made by Okada Seiko) so that the thickness h on the core surface would be 0.15 μm, and the coating was dried. The layer thickness was adjusted by varying the amount of solution. The carrier thus obtained was baked for 1 hour at 150° C. in an electric furnace, then cooled, after which it was broken up with a sieve having a mesh of 100 μm, which gave a carrier I. The average thickness T was 0.20 μm.

The volumetric average particle diameter of the core was measured using an SRA type of Microtrac particle size analyzer (made by Nikkiso), with its measuring range set at 0.7 μm or more and 125 μm or less.

The average thickness h (μm) of the resin portion of the cover layer was found by observing a carrier cross section with a transmission electron microscope (TEM), letting ha be the thickness of the resin portion present between the core surface and a particle, h_{b} be the thickness of the resin portion present between particles, and h_{c} the thickness of the resin portion over the particles or the core, measuring 50 points at a spacing of 0.2 μm along the carrier surface, and averaging the measured values thus obtained.

The thickness T (μm) from the core surface to the cover layer surface was found by observing a carrier cross section with a transmission electron microscope (TEM), measuring the thickness T (μm) from the core surface to the cover layer surface at 50 points at a spacing of 0.2 μm along the carrier surface, and averaging the measured values thus obtained.

### Manufacturing Example 2

The carrier II shown in Table 2 was obtained in exactly the same manner as in Manufacturing Example 1, except that the core b shown in Table 1 was used as the carrier core. The average thickness T was 0.20 μm.

### Manufacturing Example 3

| | | |
|---|---|---|
| acrylic resin solution | 1,500 | parts |
| (solids concentration: 50 wt %) | | |
| silicone resin solution | 1,575 | parts |
| (solids concentration: 20 wt %) | | |
| aminosilane (solids concentration: 100 wt %) | 4 | parts |
| silica microparticles | 1,500 | parts |
| (volumetric average diameter: 0.07 μm) | | |
| toluene | 6,000 | parts |

A carrier III was obtained in the same manner as in Manufacturing Example 1, except that the materials of the resin layer formation solution were changed as above. The average thickness T was 0.20 μm.

### Manufacturing Example 4

| | | |
|---|---|---|
| acrylic resin solution | 1,500 | parts |
| (solids concentration: 50 wt %) | | |
| guanamine solution (solids: 70 wt %) | 450 | parts |
| aminosilane (solids concentration: 100 wt %) | 4 | parts |
| silica microparticles | 1,500 | parts |
| (volumetric average diameter: 0.07 μm) | | |
| toluene | 6,000 | parts |

A carrier IV was obtained in the same manner as in Manufacturing Example 1, except that the materials of the resin layer formation solution were changed as above. The average thickness T was 0.20 μm.

### Manufacturing Example 5

The carrier V shown in Table 2 was obtained in exactly the same manner as in Manufacturing Example 4, except that the core c shown in Table 1 was used as the carrier core. The average thickness T was 0.20 μm.

### Manufacturing Example 6

The carrier VI shown in Table 2 was obtained in exactly the same manner as in Manufacturing Example 4, except that the core d shown in Table 1 was used as the carrier core. The average thickness T was 0.20 μm.

### Manufacturing Example 7

The carrier VII shown in Table 2 was obtained in exactly the same manner as in Manufacturing Example 4, except that the core e shown in Table 1 was used as the carrier core. The average thickness T was 0.20 μm.

### Manufacturing Example 8

The carrier VIII shown in Table 2 was obtained in exactly the same manner as in Manufacturing Example 4, except that the core f shown in Table 1 was used as the carrier core. The average thickness T was 0.20 μm.

### Manufacturing Example 9

The carrier IX shown in Table 2 was obtained in exactly the same manner as in Manufacturing Example 4, except that the core g shown in Table 1 was used as the carrier core. The average thickness T was 0.20 μm.

### Manufacturing Example 10

The carrier X shown in Table 2 was obtained in exactly the same manner as in Manufacturing Example 4, except that the core h shown in Table 1 was used as the carrier core. The average thickness T was 0.20 μm.

### Manufacturing Example 11

The carrier XI shown in Table 2 was obtained in exactly the same manner as in Manufacturing Example 4, except that the core i shown in Table 1 was used as the carrier core. The average thickness T was 0.20 μm.

### Manufacturing Example 12

The carrier XII shown in Table 2 was obtained in exactly the same manner as in Manufacturing Example 4, except that the core j shown in Table 1 was used as the carrier core. The average thickness T was 0.20 μm.

### Manufacturing Example 13

The carrier XIII shown in Table 2 was obtained in exactly the same manner as in Manufacturing Example 4, except that the core k shown in Table 1 was used as the carrier core. The average thickness T was 0.20 μm.

### Manufacturing Example 14

The carrier XIV shown in Table 2 was obtained in exactly the same manner as in Manufacturing Example 4, except that the core l shown in Table 1 was used as the carrier core. The average thickness T was 0.20 μm.

### Manufacturing Example 15

The carrier XV shown in Table 2 was obtained in exactly the same manner as in Manufacturing Example 4, except that the core m shown in Table 1 was used as the carrier core. The average thickness T was 0.20 μm.

### Manufacturing Example 16

| | | |
|---|---|---|
| acrylic resin solution | 2,130 | parts |
| (solids concentration: 50 wt %) | | |
| aminosilane (solids concentration: 100 wt %) | 4 | parts |
| silica microparticles | 1,500 | parts |
| (volumetric average diameter: 0.35 μm) | | |
| toluene | 6,000 | parts |

A carrier XVI was obtained in the same manner as in Manufacturing Example 15, except that the materials of the resin layer formation solution were changed as above. The average thickness T was 0.40 μm.

### Manufacturing Example 17

| | | |
|---|---|---|
| acrylic resin solution | 2,130 | parts |
| (solids concentration: 50 wt %) | | |
| aminosilane (solids concentration: 100 wt %) | 4 | parts |
| alumina microparticles | 1,500 | parts |
| (volumetric average diameter: 0.37 μm) | | |
| toluene | 6,000 | parts |

A carrier XVII was obtained in the same manner as in Manufacturing Example 15, except that the materials of the resin layer formation solution were changed as above. The average thickness T was 0.41 μm.

### Manufacturing Example 18

| | | |
|---|---|---|
| acrylic resin solution | 2,130 | parts |
| (solids concentration: 50 wt %) | | |
| aminosilane (solids concentration: 100 wt %) | 4 | parts |
| alumina microparticles | 1,500 | parts |
| (volumetric average diameter: 0.37 μm) | | |
| zinc oxide particles | 500 | parts |
| (volumetric average diameter: 0.020 μm) | | |
| toluene | 6,000 | parts |

A carrier XVIII was obtained in the same manner as in Manufacturing Example 15, except that the materials of the resin layer formation solution were changed as above. The average thickness T was 0.41 μm.

### Manufacturing Example 19

| | | |
|---|---|---|
| acrylic resin solution | 2,130 | parts |
| (solids concentration: 50 wt %) | | |
| aminosilane (solids concentration: 100 wt %) | 4 | parts |
| alumina microparticles | 1,500 | parts |
| (volumetric average diameter: 0.37 μm) | | |
| titanium oxide particles | 500 | parts |
| (volumetric average diameter: 0.015 μm) | | |
| toluene | 6,000 | parts |

A carrier XIX was obtained in the same manner as in Manufacturing Example 15, except that the materials of the resin layer formation solution were changed as above. The average thickness T was 0.41 μm.

### Manufacturing Example 20

A carrier XX was obtained in the same manner as in Manufacturing Example 15, except that the resin solution coating amount was changed so that the thickness h would be 0.05 μm. The average thickness T was 0.09 μm.

### Manufacturing Example 21

A carrier XXI was obtained in the same manner as in Manufacturing Example 19, except that the resin solution coating amount was changed so that the thickness h would be 2.40 μm. The average thickness T was 3.03 μm.

### Example 1

7 parts of the toner A obtained in the toner manufacturing examples and 93 parts of the carrier I obtained in carrier Manufacturing Example 1 were stirred for 10 minutes in a mixer to produce a developer to be held in a developing apparatus. Also, 80 parts of the toner A obtained in the toner manufacturing examples and 20 parts of the carrier I obtained in carrier Manufacturing Example 1 were stirred for 10 minutes in a mixer to produce a supply developer.

### Image Fineness

The developer in the developing apparatus and the supply developer were placed in a modified apparatus in which the developing apparatus shown in FIG. 4 was installed in a commercially available full-color printer (Imagio Neo C600 made by Ricoh), a letter chart with an image surface area of 5% (size of one letter about 2 mm×2 mm) was outputted, and the fineness of the image was evaluated from the letter reproducibility. The evaluation was conducted with the following ranking.
AA: Excellent
A: good
B: permissible
C: impractical level

### (Durability)

A running test for durability evaluation was conducted by outputting 100,000 of the images used for the above-mentioned image fineness evaluation. Durability was evaluated from the decrease in the carrier chargeability and the amount of change in resistance before and after this running test.

The decrease in the carrier chargeability was measured by the following method.

First, toner was mixed in an amount of 7 wt % with the initial toner (93 wt %), and this mixture was triboelectrically charged to prepare a sample, which was measured by a standard blow-off method (TB-200 made by Toshiba Chemical), and this value was termed the initial charge amount. Next, the toner was removed with the above-mentioned blow-off apparatus from the developer that had gone through the running test, and fresh toner (7 wt %) was mixed into the resulting carrier (93 wt %), and this mixture was triboelectrically charged to prepare a sample in the same manner as with the initial carrier. The amount of charge for this sample was measured in the same manner as for the initial carrier, and the difference from the initial amount of charge was termed the decrease in chargeability. The target value for decrease in chargeability is 10.0 μC/g or less. Toner-spent on the carrier surface is believed to be the main cause of a decrease in chargeability, and this decrease in chargeability can be minimized by reducing toner-spent.

The amount of change in carrier resistance was measured as follows.

The carrier was placed between parallel electrodes (2 mm gap) for resistance measurement, direct current of 1000 V was applied, and the resistance after 30 seconds was measured with a High Resistance Meter. The value thus obtained was converted to volumetric resistivity, and this value was termed the initial resistance. Next, the toner was removed from the post-running developer with the above-mentioned blow-off apparatus, resistance was measured by the same method as above with respect to the resulting carrier, the value thus obtained was converted to volumetric resistivity, and the difference from the initial resistance value was termed the amount of change in carrier resistance. The target value for the amount of change in carrier resistance is 3.0 [Log(Ω·cm)] or less. Causes of change in resistance include the shaving of the cover layer of the carrier, toner-spent, fall-out of large particles from the carrier cover layer, and so forth, and changes in the carrier resistance can be minimized by reducing these factors.

### (Charging Stability Versus Toner Concentration Changes)

Toner was mixed in an amount of 10 wt % with the initial toner (90 wt %), and this mixture was triboelectrically charged to prepare a sample, which was measured for amount of charge the same method as the initial charge amount measurement performed in the above-mentioned durability test, and the difference from the initial charge amount in the durability test (the change in the charge amount) was used to indicate the charging stability versus changes in toner concentration. The target value (absolute value) for change in charge amount is 4.0 (μC/g) or less.

### (Carrier Adhesion to Background)

The developer in the developing apparatus and the supply developer were placed in a modified apparatus in which the developing apparatus shown in FIG. 4 was installed in a commercially available full-color printer (Imagio Neo C600 made by Ricoh), the background potential was fixed at 150 V, an A3 letter chart with an image surface area of 1% (size of one letter about 2 mm×2 mm) was outputted, and the carrier adhesion was evaluated from the number of occurrences on the background. The evaluation was conducted with the following ranking.
AA: zero
A: 2 or more, 5 or fewer
B: 6 or more, 10 or fewer
C: 11 or more

### Comparative Example 1

Evaluation was performed in the same manner as in Example 1, except for using an unmodified Imagio Neo C600 (the developing apparatus shown in FIG. 4 was not installed) for the evaluation apparatus, no supplying or recovering the developer, and changing to a system that supplied only toner to the developing apparatus.

### Comparative Examples 2 to 6, Examples 2 to 16

Evaluation was performed in the same manner as in Example 1, except that the carrier used for the developer in the developing apparatus and the supply developer was the combinations shown in Table 2, using the carriers produced in Manufacturing Examples 2 to 21.

### Example 17

Evaluation was performed in the same manner as in Example 1, except that the supply developer was produced using 98 parts of the toner A obtained in the toner manufacturing examples, and 2 parts of carrier XIX obtained in carrier Manufacturing Example 19.

### Example 18

Evaluation was performed in the same manner as in Example 1, except that the supply developer was produced using 69 parts of the toner A obtained in the toner manufacturing examples, and 31 parts of carrier XIX obtained in carrier Manufacturing Example 19.

### Example 19

Evaluation was performed in the same manner as in Example 1, except that the developer in the developing apparatus was produced using 16 parts of the toner A obtained in the toner manufacturing examples, and 84 parts of carrier XIX obtained in carrier Manufacturing Example 19.

### Example 20

Evaluation was performed in the same manner as in Example 1, except that the developer in the developing apparatus was produced using 1 part by weight of the toner A obtained in the toner manufacturing examples, and 99 parts of carrier XIX obtained in carrier Manufacturing Example 19.

The carrier cores used in the manufacturing examples are shown in Table 1, the carriers produced in the manufacturing examples are shown in Table 2, and the combinations and evaluation results of Examples 1 to 20 and Comparative Examples 1 to 6 are shown in Table 3.

TABLE 1

| | | | 20 μm | 36 μm | | |
|---|---|---|---|---|---|---|
| | Dw | Dw/ | or less | or less | Magnetization | |
| Core | (μm) | Dp | (%) | (%) | (emu/g) | Core material |
| a | 22.1 | 1.09 | 6.9 | 94.2 | 48 | Cu—Zn ferrite |
| b | 31.5 | 1.17 | 5.4 | 90.3 | 48 | Cu—Zn ferrite |
| c | 21.5 | 1.10 | 6.9 | 95.5 | 48 | Cu—Zn ferrite |
| d | 32.1 | 1.15 | 5.6 | 91.4 | 48 | Cu—Zn ferrite |
| e | 24.5 | 1.23 | 6.8 | 92.3 | 48 | Cu—Zn ferrite |
| f | 22.1 | 1.10 | 7.4 | 93.9 | 48 | Cu—Zn ferrite |
| g | 23.9 | 1.13 | 6.7 | 88.9 | 48 | Cu—Zn ferrite |
| h | 28.4 | 1.13 | 6.2 | 91.2 | 54 | Cu—Zn ferrite |
| i | 27.6 | 1.14 | 6.5 | 92.1 | 98 | iron powder |
| j | 28.8 | 1.12 | 6.4 | 91.1 | 104 | iron powder |
| k | 26.0 | 1.09 | 6.3 | 91.9 | 75 | magnetite |
| l | 25.5 | 1.14 | 6.5 | 91.8 | 77 | manganese |
| | | | | | | ferrite |
| m | 25.3 | 1.12 | 6.2 | 92.5 | 76 | Mn—Mg—Sr |
| | | | | | | ferrite |

TABLE 2

| | | | | 20 μm | 36 μm | | Av. | | | | | | | |
|---|---|---|---|---|---|---|---|---|---|---|---|---|---|---|
| | | | | or less | or less | Magnetization | thick. | First hard | D1 | | 2nd hard | D2 | | Av. thick. T |
| | Carrier | Dw | Dw/Dp | (%) | (%) | (emu/g) | h (μm) | particles | (μm) | D1/h | particles | (μm) | D2/h | (μm) |
| M. E. 1 | I | 22.5 | 1.11 | 6.8 | 94.1 | 48 | 0.15 | silica | 0.07 | 0.47 | — | — | — | 0.20 |
| M. E. 2 | II | 31.9 | 1.18 | 5.3 | 90.2 | 48 | 0.15 | silica | 0.07 | 0.47 | — | — | — | 0.20 |
| M. E. 3 | III | 22.5 | 1.11 | 6.8 | 94.1 | 48 | 0.15 | silica | 0.07 | 0.47 | — | — | — | 0.20 |
| M. E. 4 | IV | 22.6 | 1.11 | 6.7 | 94.1 | 48 | 0.15 | silica | 0.07 | 0.47 | — | — | — | 0.20 |
| M. E. 5 | V | 21.9 | 1.13 | 6.8 | 95.4 | 48 | 0.15 | silica | 0.07 | 0.47 | — | — | — | 0.20 |
| M. E. 6 | VI | 32.5 | 1.16 | 5.4 | 91.3 | 48 | 0.15 | silica | 0.07 | 0.47 | — | — | — | 0.20 |
| M. E. 7 | VII | 24.9 | 1.22 | 6.7 | 92.2 | 48 | 0.15 | silica | 0.07 | 0.47 | — | — | — | 0.20 |
| M. E. 8 | VIII | 22.5 | 1.10 | 7.3 | 93.8 | 48 | 0.15 | silica | 0.07 | 0.47 | — | — | — | 0.20 |
| M. E. 9 | IX | 24.3 | 1.14 | 6.6 | 88.8 | 48 | 0.15 | silica | 0.07 | 0.47 | — | — | — | 0.20 |
| M. E. 10 | X | 28.8 | 1.14 | 6.1 | 91.1 | 54 | 0.15 | silica | 0.07 | 0.47 | — | — | — | 0.20 |
| M. E. 11 | XI | 28.0 | 1.15 | 6.4 | 92.0 | 98 | 0.15 | silica | 0.07 | 0.47 | — | — | — | 0.20 |
| M. E. 12 | XII | 29.2 | 1.13 | 6.3 | 91.0 | 104 | 0.15 | silica | 0.07 | 0.47 | — | — | — | 0.20 |
| M. E. 13 | XIII | 26.4 | 1.10 | 6.2 | 91.8 | 75 | 0.15 | silica | 0.07 | 0.47 | — | — | — | 0.20 |
| M. E. 14 | XIV | 25.9 | 1.14 | 6.4 | 91.7 | 77 | 0.15 | silica | 0.07 | 0.47 | — | — | — | 0.20 |
| M. E. 15 | XV | 25.7 | 1.13 | 6.2 | 92.4 | 76 | 0.15 | silica | 0.07 | 0.47 | — | — | — | 0.20 |
| M. E. 16 | XVI | 26.1 | 1.13 | 6.1 | 92.2 | 76 | 0.15 | silica | 0.35 | 2.33 | — | — | — | 0.40 |
| M. E. 17 | XVII | 26.1 | 1.13 | 6.1 | 92.2 | 76 | 0.15 | alumina | 0.37 | 2.47 | — | — | — | 0.41 |
| M. E. 18 | XVIII | 26.1 | 1.14 | 6.1 | 92.3 | 76 | 0.15 | alumina | 0.37 | 2.47 | zinc oxide | 0.020 | 0.133 | 0.41 |
| M. E. 19 | XIX | 26.1 | 1.14 | 6.0 | 92.3 | 76 | 0.15 | alumina | 0.37 | 2.47 | titanium | 0.015 | 0.100 | 0.41 |
| | | | | | | | | | | | oxide | | | |
| M. E. 20 | XX | 25.5 | 1.12 | 6.1 | 92.4 | 76 | 0.05 | silica | 0.07 | 1.40 | — | — | — | 0.09 |
| M. E. 21 | XXI | 31.4 | 1.11 | 5.9 | 92.1 | 75 | 2.40 | alumina | 0.37 | 0.15 | titanium | 0.015 | 0.006 | 3.03 |
| | | | | | | | | | | | oxide | | | |

M. E.: Manufacturing Example

TABLE 3

| | | Carrier wt. | Carrier wt. | | | | | | | |
|---|---|---|---|---|---|---|---|---|---|---|
| | | ratio of | ratio of | | | Decrease in | | | | |
| | | developer in | supply | | Initial | charging | Change in | Volumetric | Change in | Carrier |
| | | devel. app. | developer | Image | charge | capability | charge | resistance | resistance | adhesion to |
| | Carrier | (wt %) | (wt %) | definition | (μC/g) | (μC/g) | (μC/g) | log(Ω ·cm) | log(Ω ·cm) | background |
| W. E. 1 | I | 93 | 20 | A | 35 | 5.8 | 1.9 | 15.3 | 1.8 | B |
| C. E. 1 | I | 93 | 20 | A | 35 | 14.8 | 1.9 | 15.3 | 3.8 | B |
| W. E. 2 | II | 93 | 20 | A | 34 | 5.8 | 3.8 | 15.2 | 1.9 | B |
| W. E. 3 | III | 93 | 20 | A | 37 | 5.2 | 2.1 | 15.4 | 1.6 | B |
| W. E. 4 | IV | 93 | 20 | A | 36 | 5.7 | 2.0 | 15.5 | 1.6 | B |
| C. E. 2 | V | 93 | 20 | AA | 38 | 5.5 | 1.9 | 15.5 | 1.5 | C |
| C. E. 3 | VI | 93 | 20 | C | 33 | 4.9 | 4.3 | 15.4 | 2.4 | AA |
| C. E. 4 | VII | 93 | 20 | A | 37 | 6.0 | 2.5 | 15.5 | 1.5 | C |
| C. E. 5 | VIII | 93 | 20 | AA | 37 | 6.1 | 2.1 | 15.5 | 1.4 | C |
| C. E. 6 | IX | 93 | 20 | C | 34 | 5.1 | 2.9 | 15.5 | 2.3 | A |
| Ex. 5 | X | 93 | 20 | A | 36 | 5.8 | 3.3 | 15.5 | 1.5 | A |
| Ex. 6 | XI | 93 | 20 | A | 36 | 5.4 | 3.1 | 15.5 | 2.0 | AA |
| Ex 7 | XII | 93 | 20 | B | 36 | 5.2 | 3.4 | 15.5 | 2.1 | AA |
| Ex. 8 | XIII | 93 | 20 | AA | 36 | 5.9 | 2.8 | 15.4 | 1.8 | AA |
| Ex. 9 | XIV | 93 | 20 | AA | 36 | 6.0 | 2.7 | 15.5 | 1.7 | AA |
| Ex. 10 | XV | 93 | 20 | AA | 36 | 5.9 | 2.6 | 15.5 | 1.7 | AA |
| Ex. 11 | XVI | 93 | 20 | A | 33 | 6.5 | 2.7 | 15.7 | 1.3 | AA |
| Ex. 12 | XVII | 93 | 20 | A | 33 | 6.7 | 2.5 | 15.6 | 1.1 | AA |
| Ex. 13 | XVIII | 93 | 20 | A | 32 | 7.2 | 2.7 | 15.4 | 0.9 | AA |
| Ex. 14 | XIX | 93 | 20 | A | 31 | 7.6 | 2.6 | 15.3 | 0.7 | AA |
| Ex. 15 | XX | 93 | 20 | AA | 29 | 4.0 | 2.6 | 14.8 | 2.5 | A |
| Ex. 16 | XXI | 93 | 20 | A | 36 | 6.2 | 3.7 | 15.7 | 0.6 | B |
| Ex. 17 | XIX | 93 | 2 | A | 31 | 8.9 | 2.6 | 15.3 | 0.8 | AA |
| Ex. 18 | XIX | 93 | 31 | A | 31 | 4.8 | 2.6 | 15.3 | 2.7 | AA |
| Ex. 19 | XIX | 84 | 20 | B | 31 | 8.5 | 2.6 | 15.3 | 1.0 | AA |
| Ex. 20 | XIX | 99 | 20 | B | 31 | 4.6 | 2.6 | 15.3 | 2.6 | AA |

Ex.: Example;
C. E.: Comparative Example

What is claimed is:

1. A carrier for an electrophotographic developer, comprising:
core particles; and
a cover layer covering the particles,
wherein the carrier is used in an image forming apparatus that supplies toner and carrier to a developing apparatus in which toner and carrier are contained and that performs developing while discharging excess developer inside the developing apparatus, and
wherein at least one of the carrier to be supplied in the developing apparatus and carrier contained in the developing apparatus has a weight average particle diameter Dw of 22 μm or more and 32 μm or less, a ratio Dw/Dp of the weight average particle diameter Dw to the number average particle diameter Dp that satisfies the relationship 1.00≦Dw/Dp≦1.20, particles whose particle diameter x (μm) is within a range of 0<x<20 in an amount of 7 wt % or less, and particles whose particle diameter y (μm) is within a range of 0<y<36 in an amount of 90 wt % or more and 100 wt % or less.

2. The carrier for an electrophotographic developer according to claim 1, wherein the cover layer comprises a binder resin and at least one type of hard particles, and a hard particle diameter D1 (μm) and an average thickness h (μm) of a resin portion of the cover layer satisfy the relationship 1<(D1/h)<10.

3. The carrier for an electrophotographic developer according to claim 2, wherein the hard particles are any one of alumina particles and particles having alumina base particles.

4. The carrier for an electrophotographic developer according to claim 2, wherein the cover comprises second hard particles in addition to the hard particles, the hard particle diameter D1 (μm) and a second hard particle diameter D2 satisfy the relationship D2<D1, and the second hard particle diameter D2 (μm) and the average thickness h (μm) of the resin portion of the cover layer satisfy the relationship 0.001<(D2/h)<1.

5. The carrier for an electrophotographic developer according to claim 4, wherein the second hard particles are any one of titanium oxide particles and surface-treated titanium oxide particles.

6. The carrier for an electrophotographic developer according to claim 1, wherein an average thickness T (μm) from a core particle surface to a surface of the cover layer is within a range of 0.1<T<3.0.

7. The carrier for an electrophotographic developer according to claim 1, wherein the binder resin comprises at least a reaction product of an acrylic resin and an amino resin, or a silicone resin.

8. The carrier for an electrophotographic developer according to claim 1, wherein magnetization as measured when a magnetic field of 1000 oersteds is applied to the carrier is 50 emu/g or more and 100 emu/g or less.

9. The carrier for an electrophotographic developer according to claim 1, wherein the core particles are any one of Mn—Mg—Sr ferrite, Mn ferrite and magnetite.

10. An electrophotographic developer comprising:
a toner; and
a carrier which comprises core particles and a cover layer covering the particles,
wherein the carrier is used in an image forming apparatus that supplies toner and carrier to a developing apparatus in which toner and carrier are contained and that performs developing while discharging excess developer inside the developing apparatus, and
wherein at least one of the carrier to be supplied in the developing apparatus and carrier contained in the developing apparatus has a weight average particle diameter Dw of 22 μm or more and 32 μm or less, a ratio Dw/Dp of the weight average particle diameter Dw to the number average particle diameter Dp that satisfies the relationship 1.00≦Dw/Dp≦1.20, particles whose particle diameter x (μm) is within a range of 0<x<20 in an amount of 7 wt % or less, and particles whose particle diameter y (μm) is within a range of 0<y<36 in an amount of 90 wt % or more and 100 wt % or less.

11. The electrophotographic developer according to claim 10, wherein a content of the carrier in the supply developer in the developing apparatus is 3 wt % or more and less than 30 wt %.

12. The electrophotographic developer according to claim 10, wherein a content of the carrier in the developer contained in the developing apparatus is 85 wt % or more and less than 98 wt %.

13. An image formation method comprising:
forming a latent electrostatic image on an image bearing member; and
developing the latent electrostatic image to form a visible image by supplying a toner and carrier to a developing apparatus in which a toner and carrier are contained while discharging excess developer inside the developing apparatus,
wherein the carrier comprises core particles and a cover layer covering the particles, and
wherein at least one of the carrier to be supplied in the developing apparatus and carrier contained in the developing apparatus has a weight average particle diameter Dw of 22 μm or more and 32 μm or less, a ratio Dw/Dp of the weight average particle diameter Dw to the number average particle diameter Dp that satisfies the relationship 1.00≦Dw/Dp≦1.20, particles whose particle diameter x (μm) is within a range of 0<x<20 in an amount of 7 wt % or less, and particles whose particle diameter y (μm) is within a range of 0<y<36 in an amount of 90 wt % or more and 100 wt % or less.

14. An image forming apparatus comprising:
an image bearing member for bearing thereon a latent electrostatic image;
a developing apparatus configured to develop the latent electrostatic image by use of a developer containing a toner and carrier to form a visual image;
a developer supply unit configured to supply the toner and carrier to the developing apparatus; and
a developer discharge unit configured to discharge residual particles of the developer contained in the developing apparatus,
wherein the carrier comprises core particles and a cover layer covering the particles, and
wherein at least one of the carrier to be supplied in the developing apparatus and carrier contained in the developing apparatus has a weight average particle diameter Dw of 22 μm or more and 32 μm or less, a ratio Dw/Dp of the weight average particle diameter Dw to the number average particle diameter Dp that satisfies the relationship 1.00≦Dw/Dp≦1.20, particles whose particle diameter x (μm) is within a range of 0<x<20 in an amount of 7 wt % or less, and particles whose particle diameter y (μm) is within a range of 0<y<36 in an amount of 90 wt % or more and 100 wt % or less.

15. The image forming apparatus according to claim 14, further comprising:
a container for containing therein a supply developer, the container having a readily deformable shape; and
a suction pump for drawing the supply developer in the container for supply into the developing apparatus.

16. A process cartridge comprising:
an image bearing member; and
a developing apparatus which at least converts a latent electrostatic image formed on the image bearing member into a visible image using a developer including a toner and carrier,
the process cartridge being detachably provided to a main body of an image forming apparatus, a main body side of the image forming apparatus being provided with a unit configured to supply toner and carrier to the developing apparatus and with a developer discharge unit configured to discharge excess developer from inside the developing apparatus,
wherein the carrier comprises core particles and a cover layer covering the particles, and
wherein at least one of the carrier to be supplied in the developing apparatus and carrier contained in the developing apparatus has a weight average particle diameter Dw of 22 μm or more and 32 μm or less, a ratio Dw/Dp of the weight average particle diameter Dw to the number average particle diameter Dp that satisfies the relationship 1.00≦Dw/Dp≦1.20, particles whose particle diameter x (μm) is within a range of 0<x<20 in an amount of 7 wt % or less, and particles whose particle diameter y (μm) is within a range of 0<y<36 in an amount of 90 wt % or more and 100 wt % or less.
